(19) United States
(12) Patent Application Publication
(10) Pub. No.: US 2024/0413947 A1
(43) Pub. Date: Dec. 12, 2024

(54) METHOD, APPARATUS, AND SYSTEM FOR MULTI-STATIC SENSING AND COMMUNICATION

(71) Applicant: Huawei Technologies Co., Ltd., Shenzhen (CN)

(72) Inventors: Shahram Shahsavari, Ottawa (CA); Alireza Bayesteh, Brossard (CA); Jianglei Ma, Ottawa (CA); Wen Tong, Ottawa (CA)

(21) Appl. No.: 18/813,420

(22) Filed: Aug. 23, 2024

Related U.S. Application Data
(63) Continuation of application No. PCT/CN2022/077679, filed on Feb. 24, 2022.

(51) Int. Cl. H04L 5/00

(52) U.S. Cl. CPC H04L 5/005; H04L 5/0035; H04L 5/0094

(57) ABSTRACT

Some embodiments of the present disclosure provide a scheme for multiplexing of sensing pilot signals and data content signals. For example, some embodiments include obtaining, at a sensing pilot signal transmitting node, a time-frequency pattern specific to the sensing pilot signal transmitting node. The time-frequency pattern indicates, for a first plurality of resource blocks, a second plurality of resource blocks that are to be used for transmitting a plurality of sensing pilot signals, and a sensing pilot signal parameter for each sensing pilot signal among the plurality of sensing pilot signals. Some embodiments further include transmitting, to a sensing pilot signal receiving node and in accordance with the time-frequency pattern, a particular sensing pilot signal among the plurality of sensing pilot signals.

### CROSS-REFERENCE TO RELATED APPLICATION

This application is a continuation of International Application No. PCT/CN2022/077679, filed on Feb. 24, 2022, the disclosure of which is hereby incorporated by reference in its entirety.

### TECHNICAL FIELD

The present disclosure relates, generally, to integrated sensing and communication and, in particular embodiments, to facilitating multi-static sensing and communication.

### BACKGROUND

It has been recognized that it is beneficial to integrate data communication and sensing in some wireless communications networks. Sensing, in some contexts, refers to an operation to detect, for a particular target, a range, a velocity and/or a shape. Radar is a common example of a technology employed for sensing.

It is known that a wireless communications network may operate to allow for plentiful data communication in the absence of sensing. It is also known that, by making use of information that may be gained through the use of sensing, either of a general environment or of a particular channel, may significantly enhance elements of data communication. Unfortunately, when resources are employed for sensing purposes, the same resources may not be used for data communication purposes. An appropriate balance is sought between the cost of use of resources for sensing and the benefits obtained by using the resources for sensing.

### SUMMARY

To facilitate the multiplexing of sensing pilot signals and data content signals, a mapping generator may generate a time-frequency pattern specific to a sensing pilot signal transmitting node. The time-frequency pattern may indicate, for a plurality of resource blocks, a plurality of first resource blocks that are to be used for transmitting a plurality of sensing pilot signals, a plurality of second resource blocks that are to be used for transmitting data content signals and a sensing pilot signal parameter for each sensing pilot signal among the plurality of sensing pilot signals. A sensing pilot signal receiving node may process a received version of a given sensing pilot signal to obtain an estimate of a sensing parameter that characterizes a difference between a transmitted version of the given sensing pilot signal and the received version of the given sensing pilot signal.

Multi-static sensing has, to this point, not been compatible with high data rate communication.

However, aspects of the present application may be shown to enable cooperative, multi-static sensing in combination with high data rate communication. Additionally, aspects of the present application may be shown to enable multiple access for multi-static sensing so as to enable the cooperative sensing while avoiding or minimizing collisions.

According to an aspect of the present disclosure, there is provided a method of facilitating sensing. The method includes generating a time-frequency pattern specific to a sensing pilot signal transmitting node, the time-frequency pattern indicating, for a plurality of resource blocks, a plurality of resource blocks that are to be used for transmitting a plurality of sensing pilot signals and a sensing pilot signal parameter for each sensing pilot signal among the plurality of sensing pilot signals.

According to an aspect of the present disclosure, there is provided a sensing management function. The sensing management function includes a memory storing instructions and a processor. The processor is caused, by executing the instructions, to generate a time-frequency pattern specific to a sensing pilot signal transmitting node, the time-frequency pattern indicating, for a plurality of resource blocks, a plurality of resource blocks that are to be used for transmitting a plurality of sensing pilot signals and a sensing pilot signal parameter for each sensing pilot signal among the plurality of sensing pilot signals.

According to an aspect of the present disclosure, there is provided a method of facilitating sensing. The method includes accessing, at a sensing pilot signal transmitting node, a time-frequency pattern specific to the sensing pilot signal transmitting node, the time-frequency pattern indicating, for a plurality of resource blocks, a plurality of resource blocks that are to be used for transmitting a plurality of sensing pilot signals and a sensing pilot signal parameter for each sensing pilot signal among the plurality of sensing pilot signals. The method further includes transmitting, to a sensing pilot signal receiving node and in accordance with the time-frequency pattern, a given sensing pilot signal among the plurality of sensing pilot signals.

According to an aspect of the present disclosure, there is provided a sensing pilot signal transmitting node. The sensing pilot signal transmitting node includes a memory storing instructions, a processor and a transmitter. The processor is caused, by executing the instructions, to access a time-frequency pattern specific to the sensing pilot signal transmitting node, the time-frequency pattern indicating, for a plurality of resource blocks, a plurality of resource blocks that are to be used for transmitting a plurality of sensing pilot signals and a sensing pilot signal parameter for each sensing pilot signal among the plurality of sensing pilot signals. The transmitter is adapted to transmit, to a sensing pilot signal receiving node and in accordance with the time-frequency pattern, a given sensing pilot signal among the plurality of sensing pilot signals.

According to an aspect of the present disclosure, there is provided a method of sensing. The method includes receiving, at a sensing pilot signal receiving node from a sensing pilot signal transmitting node, a time-frequency pattern specific to the sensing pilot signal transmitting node, the time-frequency pattern indicating, for a plurality of resource blocks, a plurality of resource blocks that are to be used for transmitting a plurality of sensing pilot signals and a sensing pilot signal parameter for each sensing pilot signal among the plurality of sensing pilot signals. The method further includes receiving, from the sensing pilot signal transmitting node, a received version of a given sensing pilot signal among the plurality of sensing pilot signals and transmitting an estimate of a sensing measurement that characterizes a difference between a transmitted version of the given sensing pilot signal and the received version of the given sensing pilot signal.

According to an aspect of the present disclosure, there is provided a sensing pilot signal receiving node. The sensing pilot signal receiving node includes a receiver and a transmitter. The receiver is adapted to receive, from a sensing pilot signal transmitting node, a time-frequency pattern specific to the sensing pilot signal transmitting node, the time-frequency pattern indicating, for a plurality of resource blocks, a plurality of resource blocks that are to be used for transmitting a plurality of sensing pilot signals and a sensing pilot signal parameter for each sensing pilot signal among the plurality of sensing pilot signals. The receiver is further adapted to receive, from the sensing pilot signal transmitting node, a received version of a given sensing pilot signal among the plurality of sensing pilot signals. The transmitter is adapted to transmit an estimate of a sensing measurement that characterizes a difference between a transmitted version of the given sensing pilot signal and the received version of the given sensing pilot signal.

### BRIEF DESCRIPTION OF THE DRAWINGS

For a more complete understanding of the present embodiments, and the advantages thereof, reference is now made, by way of example, to the following descriptions taken in conjunction with the accompanying drawings, in which:

FIG. 1 illustrates, in a schematic diagram, a communication system in which embodiments of the disclosure may occur, the communication system includes multiple example electronic devices and multiple example transmit/receive points along with various networks;

FIG. 2 illustrates, in a block diagram, the communication system of FIG. 1, the communication system includes multiple example electronic devices, an example terrestrial transmit/receive point and an example non-terrestrial transmit/receive point along with various networks;

FIG. 3 illustrates, as a block diagram, elements of an example electronic device of FIG. 2, elements of an example terrestrial transmit/receive point of FIG. 2 and elements of an example non-terrestrial transmit/receive point of FIG. 2, in accordance with aspects of the present application;

FIG. 4 illustrates, as a block diagram, various modules that may be included in an example electronic device, an example terrestrial transmit/receive point and an example non-terrestrial transmit/receive point, in accordance with aspects of the present application;

FIG. 5 illustrates, as a block diagram, a sensing management function with a mapping generator, in accordance with aspects of the present application;

FIG. 6 illustrates a first example scenario with two transmit/receive points and three user equipments, in which the two transmit receive/points act as sensing signal transmitting nodes, in accordance with aspects of the present application;

FIG. 7 illustrates a first table with indications of chirp rate allocation and sensing resource block allocation for one of the transmit/receive points of FIG. 6, in accordance with aspects of the present application;

FIG. 8 illustrates a second table with indications of chirp rate allocation and sensing resource block allocation for the other of the transmit/receive points of FIG. 6, in accordance with aspects of the present application;

FIG. 9A illustrates a first chirp mapping for one of the transmit/receive points of the first example scenario illustrated in FIG. 6, in accordance with aspects of the present application;

FIG. 9B illustrates a second chirp mapping for the other of the transmit/receive points of the first example scenario illustrated in FIG. 6, in accordance with aspects of the present application;

FIG. 10 illustrates, in a signal flow diagram, interaction between a sensing management function, a plurality of transmit/receive points and a plurality of user equipments, in accordance with aspects of the present application;

FIG. 11 illustrates an example of chirp allocation mapping for transmit/receive points at a particular sample time, in accordance with aspects of the present application;

FIG. 12 illustrates a scenario with an environment and in which there are two user equipments configured to act as sensing signal transmitting nodes and sensing signal receiving nodes, in accordance with aspects of the present application;

FIG. 13 illustrates an example table of chirp allocation mapping for the user equipments of FIG. 12 at a particular sample time, in accordance with aspects of the present application;

FIG. 14 illustrates, in a signal flow diagram, interaction between a sensing management function and the elements of FIG. 12, including the environment and the two user equipments, in accordance with aspects of the present application;

FIG. 15 illustrates the mapping generator of FIG. 5 in the context of inputs to, and outputs from, the mapping generator, in accordance with aspects of the present application;

FIG. 16 illustrates an example table with indications of chirp rate allocation, data and sensing resource block allocation for a particular sensing signal transmitting node and a particular time, in accordance with aspects of the present application;

FIG. 17 illustrates a second example scenario with two transmit/receive points and three user equipments, in which the two transmit/receive points act as sensing signal transmitting nodes, in accordance with aspects of the present application;

FIG. 18A illustrates a first chirp mapping for one of the transmit/receive points of the second example scenario illustrated in FIG. 17, in accordance with aspects of the present application;

FIG. 18B illustrates a second chirp mapping for the other of the transmit/receive points of the second example scenario illustrated in FIG. 17, in accordance with aspects of the present application;

FIG. 19A illustrates a first chirp mapping for one of the transmit/receive points of the second example scenario illustrated in FIG. 17, in accordance with aspects of the present application;

FIG. 19B illustrates a second chirp mapping for the other of the transmit/receive points of the second example scenario illustrated in FIG. 17, in accordance with aspects of the present application;

FIG. 20 illustrates a third example scenario with two transmit/receive points and three user equipments, in which the two transmit/receive points act as sensing signal transmitting nodes, in accordance with aspects of the present application;

FIG. 21A illustrates a first chirp mapping for one of the transmit/receive points of the third example scenario illustrated in FIG. 20, in accordance with aspects of the present application;

FIG. 21B illustrates a second chirp mapping for the other of the transmit/receive points of the third example scenario illustrated in FIG. 20, in accordance with aspects of the present application;

FIG. 22A illustrates a first chirp mapping for one of the transmit/receive points of the second example scenario illustrated in FIG. 17, in accordance with aspects of the present application;

FIG. 22B illustrates a second chirp mapping for the other of the transmit/receive points of the second example scenario illustrated in FIG. 17, in accordance with aspects of the present application;

FIG. 23 illustrates a fourth example scenario with two transmit/receive points and three user equipments, in which the two transmit/receive points act as sensing signal transmitting nodes, in accordance with aspects of the present application;

FIG. 24A illustrates a first chirp mapping for one of the transmit/receive points of the fourth example scenario illustrated in FIG. 23, in accordance with aspects of the present application;

FIG. 24B illustrates a second chirp mapping for the other of the transmit/receive points of the fourth example scenario illustrated in FIG. 23, in accordance with aspects of the present application;

FIG. 25 illustrates a fifth example scenario with two transmit/receive points and three user equipments, in which the two transmit/receive points act as sensing signal transmitting nodes, in accordance with aspects of the present application;

FIG. 26A illustrates a first chirp mapping for one of the transmit/receive points of the fifth example scenario illustrated in FIG. 25, in accordance with aspects of the present application;

FIG. 26B illustrates a second chirp mapping for the other of the transmit/receive points of the fifth example scenario illustrated in FIG. 25, in accordance with aspects of the present application;

FIG. 27A illustrates a first chirp mapping for one of the transmit/receive points of the fifth example scenario illustrated in FIG. 25, in accordance with aspects of the present application;

FIG. 27B illustrates a second chirp mapping for the other of the transmit/receive points of the fifth example scenario illustrated in FIG. 25, in accordance with aspects of the present application;

FIG. 28A illustrates a first chirp mapping for one of the transmit/receive points of the first example scenario illustrated in FIG. 6, in accordance with aspects of the present application;

FIG. 28B illustrates a second chirp mapping for the other of the transmit/receive points of the first example scenario illustrated in FIG. 6, in accordance with aspects of the present application;

FIG. 29 illustrates an example, wherein a time-frequency pattern is defined over a pre-defined time duration and over a pre-defined bandwidth, in accordance with aspects of the present application;

FIG. 30 illustrates an example, wherein a time-frequency pattern is repeated, in accordance with aspects of the present application;

FIG. 31 illustrates an example, wherein a single time-frequency pattern is to be implemented in multiple bandwidths, in accordance with aspects of the present application;

FIG. 32 illustrates an example, wherein a plurality of time-frequency patterns are to be implemented according to a prescribed order, in accordance with aspects of the present application;

FIG. 33 illustrates an example, wherein a plurality of time-frequency patterns are to be implemented in the same time slot and different frequency ranges, in accordance with aspects of the present application; and

FIG. 34 illustrates an example, wherein a plurality of indexed time-frequency patterns are to be implemented in various time slots and various frequency ranges, in accordance with aspects of the present application.

### DETAILED DESCRIPTION OF ILLUSTRATIVE EMBODIMENTS

For illustrative purposes, specific example embodiments will now be explained in greater detail in conjunction with the figures.

The embodiments set forth herein represent information sufficient to practice the claimed subject matter and illustrate ways of practicing such subject matter. Upon reading the following description in light of the accompanying figures, those of skill in the art will understand the concepts of the claimed subject matter and will recognize applications of these concepts not particularly addressed herein. It should be understood that these concepts and applications fall within the scope of the disclosure and the accompanying claims.

Moreover, it will be appreciated that any module, component, or device disclosed herein that executes instructions may include, or otherwise have access to, a non-transitory computer/processor readable storage medium or media for storage of information, such as computer/processor readable instructions, data structures, program modules and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile discs (i.e., DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Computer/processor readable/executable instructions to implement an application or module described herein may be stored or otherwise held by such non-transitory computer/processor readable storage media.

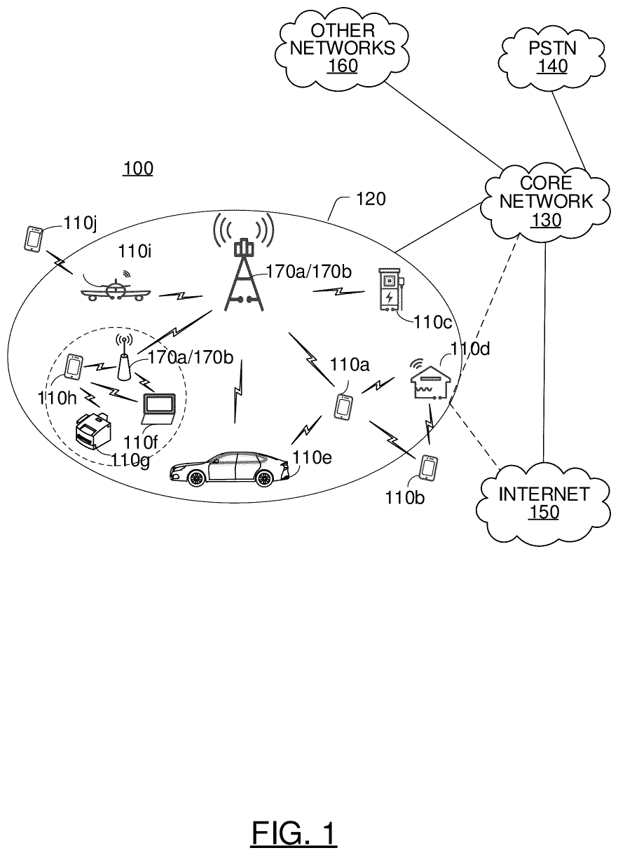

Referring to FIG. 1, as an illustrative example without limitation, a simplified schematic illustration of a communication system is provided. The communication system 100 comprises a radio access network 120. The radio access network 120 may be a next generation (e.g., sixth generation, “6G,” or later) radio access network, or a legacy (e.g., 5G, 4G, 3G or 2G) radio access network. One or more communication electric device (ED) 110a, 110b, 110c, 110d, 110e, 110f, 110g, 110h, 110i, 110j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100. Also the communication system 100 comprises a public switched telephone network (PSTN) 140, the internet 150, and other networks 160.

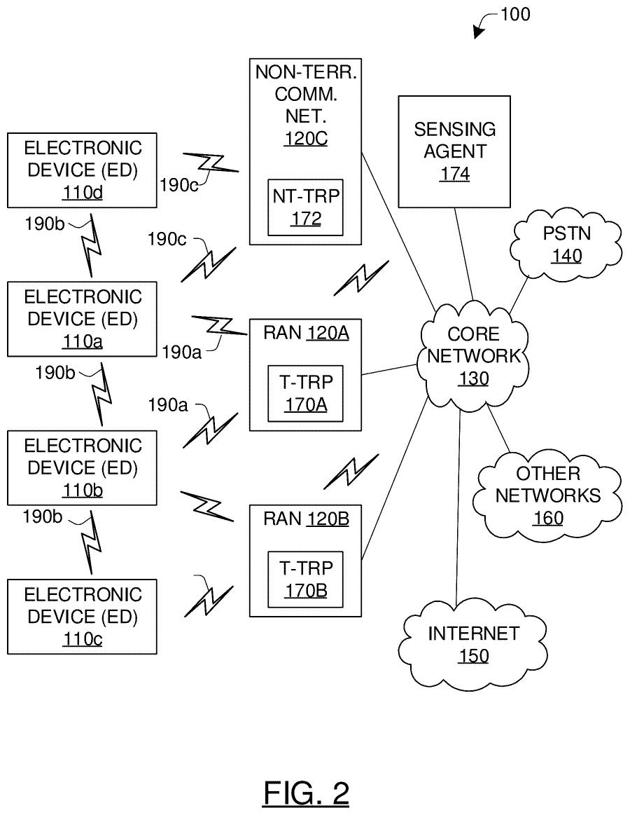

FIG. 2 illustrates an example communication system 100. In general, the communication system 100 enables multiple wireless or wired elements to communicate data and other content. The purpose of the communication system 100 may be to provide content, such as voice, data, video, and/or text, via broadcast, multicast and unicast, etc. The communication system 100 may operate by sharing resources, such as carrier spectrum bandwidth, between its constituent elements. The communication system 100 may include a terrestrial communication system and/or a non-terrestrial communication system. The communication system 100 may provide a wide range of communication services and applications (such as earth monitoring, remote sensing, passive sensing and positioning, navigation and tracking, autonomous delivery and mobility, etc.). The communication system 100 may provide a high degree of availability and robustness through a joint operation of a terrestrial communication system and a non-terrestrial communication system. For example, integrating a non-terrestrial communication system (or components thereof) into a terrestrial communication system can result in what may be considered a heterogeneous network comprising multiple layers. Compared to conventional communication networks, the heterogeneous network may achieve better overall performance through efficient multi-link joint operation, more flexible functionality sharing and faster physical layer link switching between terrestrial networks and non-terrestrial networks.

The terrestrial communication system and the non-terrestrial communication system could be considered sub-systems of the communication system. In the example shown in FIG. 2, the communication system 100 includes electronic devices (ED) 110a, 110b, 110c, 110d (generically referred to as ED 110), radio access networks (RANs) 120a, 120b, a non-terrestrial communication network 120c, a core network 130, a public switched telephone network (PSTN) 140, the Internet 150 and other networks 160. The RANs 120a, 120b include respective base stations (BSs) 170a, 170b, which may be generically referred to as terrestrial transmit and receive points (T-TRPs) 170a, 170b. The non-terrestrial communication network 120c includes an access node 172, which may be generically referred to as a non-terrestrial transmit and receive point (NT-TRP) 172. Transmit and receive points may also be referred to as transmit/receive points, or as transmission/reception points.

Any ED 110 may be alternatively or additionally configured to interface, access, or communicate with any T-TRP 170a, 170b and NT-TRP 172, the Internet 150, the core network 130, the PSTN 140, the other networks 160, or any combination of the preceding. In some examples, the ED 110a may communicate an uplink and/or downlink transmission over a terrestrial air interface 190a with T-TRP 170a. In some examples, the EDs 110a, 110b, 110c and 110d may also communicate directly with one another via one or more sidelink air interfaces 190b. In some examples, the ED 110d may communicate an uplink and/or downlink transmission over a non-terrestrial air interface 190c with NT-TRP 172.

The air interfaces 190a and 190b may use similar communication technology, such as any suitable radio access technology. For example, the communication system 100 may implement one or more channel access methods, such as code division multiple access (CDMA), space division multiple access (SDMA), time division multiple access (TDMA), frequency division multiple access (FDMA), orthogonal FDMA (OFDMA), or single-carrier FDMA (SC-FDMA) in the air interfaces 190a and 190b. The air interfaces 190a and 190b may utilize other higher dimension signal spaces, which may involve a combination of orthogonal and/or non-orthogonal dimensions.

The non-terrestrial air interface 1900 can enable communication between the ED 110d and one or multiple NT-TRPs 172 via a wireless link or simply a link. For some examples, the link is a dedicated connection for unicast transmission, a connection for broadcast transmission, or a connection between a group of EDs 110 and one or multiple NT-TRPs 175 for multicast transmission.

The RANs 120a and 120b are in communication with the core network 130 to provide the EDs 110a, 110b, 110c with various services such as voice, data and other services. The RANs 120a and 120b and/or the core network 130 may be in direct or indirect communication with one or more other RANs (not shown), which may or may not be directly served by core network 130 and may, or may not, employ the same radio access technology as RAN 120a, RAN 120b or both. The core network 130 may also serve as a gateway access between (i) the RANs 120a and 120b or the EDs 110a, 110b, 110c or both, and (ii) other networks (such as the PSTN 140, the Internet 150, and the other networks 160). In addition, some or all of the EDs 110a, 110b, 110c may include functionality for communicating with different wireless networks over different wireless links using different wireless technologies and/or protocols. Instead of wireless communication (or in addition thereto), the EDs 110a, 110b, 110c may communicate via wired communication channels to a service provider or switch (not shown) and to the Internet 150. The PSTN 140 may include circuit switched telephone networks for providing plain old telephone service (POTS). The Internet 150 may include a network of computers and subnets (intranets) or both and incorporate protocols, such as Internet Protocol (IP), Transmission Control Protocol (TCP), User Datagram Protocol (UDP). The EDs 110a, 110b, 110c may be multimode devices capable of operation according to multiple radio access technologies and may incorporate multiple transceivers necessary to support such.

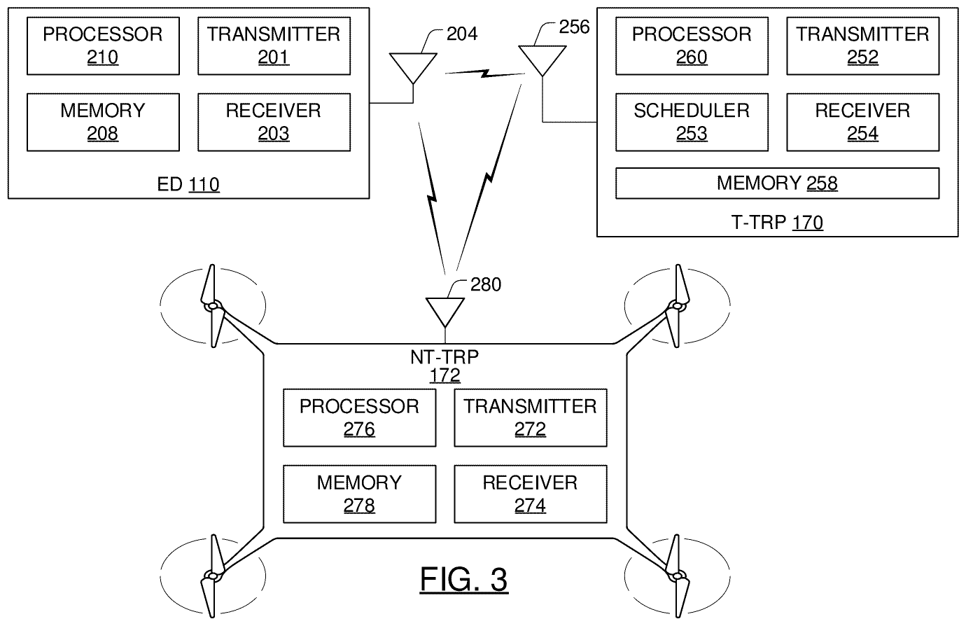

FIG. 3 illustrates another example of an ED 110 and a base station 170a, 170b and/or 170c. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), Internet of things (IoT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, an industrial device, or apparatus (e.g., communication module, modem, or chip) in the forgoing devices, among other possibilities. Future generation EDs 110 may be referred to using other terms. The base stations 170a and 170b each T-TRPs and will, hereafter, be referred to as T-TRP 170. Also shown in FIG. 3, a NT-TRP will hereafter be referred to as NT-TRP 172. Each ED 110 connected to the T-TRP 170 and/or the NT-TRP 172 can be dynamically or semi-statically turned-on (i.e., established, activated or enabled), turned-off (i.e., released, deactivated or disabled) and/or configured in response to one of more of: connection availability; and connection necessity.

The ED 110 includes a transmitter 201 and a receiver 203 coupled to one or more antennas 204. Only one antenna 204 is illustrated. One, some, or all of the antennas 204 may, alternatively, be panels. The transmitter 201 and the receiver 203 may be integrated, e.g., as a transceiver. The transceiver is configured to modulate data or other content for transmission by the at least one antenna 204 or by a network interface controller (NIC). The transceiver may also be configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by one or more processing unit(s) (e.g., a processor 210). Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache and the like.

The ED 110 may further include one or more input/output devices (not shown) or interfaces (such as a wired interface to the Internet 150 in FIG. 1). The input/output devices permit interaction with a user or other devices in the network. Each input/output device includes any suitable structure for providing information to, or receiving information from, a user, such as through operation as a speaker, a microphone, a keypad, a keyboard, a display or a touch screen, including network interface communications.

The ED 110 includes the processor 210 for performing operations including those operations related to preparing a transmission for uplink transmission to the NT-TRP 172 and/or the T-TRP 170, those operations related to processing downlink transmissions received from the NT-TRP 172 and/or the T-TRP 170, and those operations related to processing sidelink transmission to and from another ED 110. Processing operations related to preparing a transmission for uplink transmission may include operations such as encoding, modulating, transmit beamforming and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g., by detecting and/or decoding the signaling). An example of signaling may be a reference signal transmitted by the NT-TRP 172 and/or by the T-TRP 170. In some embodiments, the processor 210 implements the transmit beamforming and/or the receive beamforming based on the indication of beam direction, e.g., beam angle information (BAI), received from the T-TRP 170. In some embodiments, the processor 210 may perform operations relating to network access (e.g., initial access) and/or downlink synchronization, such as operations relating to detecting a synchronization sequence, decoding and obtaining the system information, etc. In some embodiments, the processor 210 may perform channel estimation, e.g., using a reference signal received from the NT-TRP 172 and/or from the T-TRP 170.

Although not illustrated, the processor 210 may form part of the transmitter 201 and/or part of the receiver 203. Although not illustrated, the memory 208 may form part of the processor 210.

The processor 210, the processing components of the transmitter 201 and the processing components of the receiver 203 may each be implemented by the same or different one or more processors that are configured to execute instructions stored in a memory (e.g., the in memory 208). Alternatively, some or all of the processor 210, the processing components of the transmitter 201 and the processing components of the receiver 203 may each be implemented using dedicated circuitry, such as a programmed field-programmable gate array (FPGA), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), a wireless router, a relay station, a remote radio head, a terrestrial node, a terrestrial network device, a terrestrial base station, a base band unit (BBU), a remote radio unit (RRU), an active antenna unit (AAU), a remote radio head (RRH), a central unit (CU), a distribute unit (DU), a positioning node, among other possibilities. The T-TRP 170 may be a macro BS, a pico BS, a relay node, a donor node, or the like, or combinations thereof. The T-TRP 170 may refer to the forgoing devices or refer to apparatus (e.g., a communication module, a modem or a chip) in the forgoing devices.

In some embodiments, the parts of the T-TRP 170 may be distributed. For example, some of the modules of the T-TRP 170 may be located remote from the equipment that houses antennas 256 for the T-TRP 170, and may be coupled to the equipment that houses antennas 256 over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment that houses antennas 256 of the T-TRP 170. The modules may also be coupled to other T-TRPs. In some embodiments, the T-TRP 170 may actually be a plurality of T-TRPs that are operating together to serve the ED 110, e.g., through the use of coordinated multipoint transmissions.

As illustrated in FIG. 3, the T-TRP 170 includes at least one transmitter 252 and at least one receiver 254 coupled to one or more antennas 256. Only one antenna 256 is illustrated. One, some, or all of the antennas 256 may, alternatively, be panels. The transmitter 252 and the receiver 254 may be integrated as a transceiver. The T-TRP 170 further includes a processor 260 for performing operations including those related to: preparing a transmission for downlink transmission to the ED 110; processing an uplink transmission received from the ED 110; preparing a transmission for backhaul transmission to the NT-TRP 172; and processing a transmission received over backhaul from the NT-TRP 172. Processing operations related to preparing a transmission for downlink or backhaul transmission may include operations such as encoding, modulating, precoding (e.g., multiple input multiple output, “MIMO,” precoding), transmit beamforming and generating symbols for transmission. Processing operations related to processing received transmissions in the uplink or over backhaul may include operations such as receive beamforming, demodulating received symbols and decoding received symbols. The processor 260 may also perform operations relating to network access (e.g., initial access) and/or downlink synchronization, such as generating the content of synchronization signal blocks (SSBs), generating the system information, etc. In some embodiments, the processor 260 also generates an indication of beam direction, e.g., BAI, which may be scheduled for transmission by a scheduler 253. The processor 260 performs other network-side processing operations described herein, such as determining the location of the ED 110, determining where to deploy the NT-TRP 172, etc. In some embodiments, the processor 260 may generate signaling, e.g., to configure one or more parameters of the ED 110 and/or one or more parameters of the NT-TRP 172. Any signaling generated by the processor 260 is sent by the transmitter 252. Note that “signaling,” as used herein, may alternatively be called control signaling. Dynamic signaling may be transmitted in a control channel, e.g., a physical downlink control channel (PDCCH) and static, or semi-static, higher layer signaling may be included in a packet transmitted in a data channel, e.g., in a physical downlink shared channel (PDSCH).

The scheduler 253 may be coupled to the processor 260. The scheduler 253 may be included within, or operated separately from, the T-TRP 170. The scheduler 253 may schedule uplink, downlink and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or part of the receiver 254. Also, although not illustrated, the processor 260 may implement the scheduler 253. Although not illustrated, the memory 258 may form part of the processor 260.

The processor 260, the scheduler 253, the processing components of the transmitter 252 and the processing components of the receiver 254 may each be implemented by the same, or different one of, one or more processors that are configured to execute instructions stored in a memory, e.g., in the memory 258. Alternatively, some or all of the processor 260, the scheduler 253, the processing components of the transmitter 252 and the processing components of the receiver 254 may be implemented using dedicated circuitry, such as a FPGA, a GPU or an ASIC.

Notably, the NT-TRP 172 is illustrated as a drone only as an example, the NT-TRP 172 may be implemented in any suitable non-terrestrial form. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110; processing an uplink transmission received from the ED 110; preparing a transmission for backhaul transmission to T-TRP 170; and processing a transmission received over backhaul from the T-TRP 170. Processing operations related to preparing a transmission for downlink or backhaul transmission may include operations such as encoding, modulating, precoding (e.g., MIMO precoding), transmit beamforming and generating symbols for transmission. Processing operations related to processing received transmissions in the uplink or over backhaul may include operations such as receive beamforming, demodulating received signals and decoding received symbols. In some embodiments, the processor 276 implements the transmit beamforming and/or receive beamforming based on beam direction information (e.g., BAI) received from the T-TRP 170. In some embodiments, the processor 276 may generate signaling, e.g., to configure one or more parameters of the ED 110. In some embodiments, the NT-TRP 172 implements physical layer processing but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or part of the receiver 274. Although not illustrated, the memory 278 may form part of the processor 276.

The processor 276, the processing components of the transmitter 272 and the processing components of the receiver 274 may each be implemented by the same or different one or more processors that are configured to execute instructions stored in a memory, e.g., in the memory 278. Alternatively, some or all of the processor 276, the processing components of the transmitter 272 and the processing components of the receiver 274 may be implemented using dedicated circuitry, such as a programmed FPGA, a GPU or an ASIC. In some embodiments, the NT-TRP 172 may actually be a plurality of NT-TRPs that are operating together to serve the ED 110, e.g., through coordinated multipoint transmissions.

The T-TRP 170, the NT-TRP 172, and/or the ED 110 may include other components, but these have been omitted for the sake of clarity.

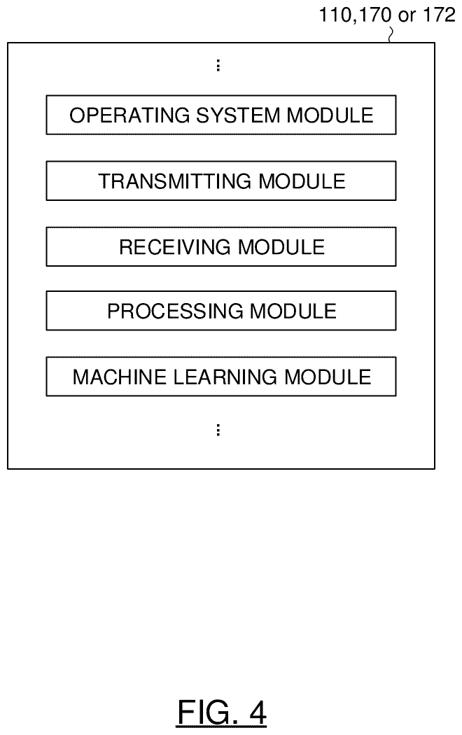

One or more steps of the embodiment methods provided herein may be performed by corresponding units or modules, according to FIG. 4. FIG. 4 illustrates units or modules in a device, such as in the ED 110, in the T-TRP 170 or in the NT-TRP 172. For example, a signal may be transmitted by a transmitting unit or by a transmitting module. A signal may be received by a receiving unit or by a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU or an ASIC. It will be appreciated that where the modules are implemented using software for execution by a processor, for example, the modules may be retrieved by a processor, in whole or part as needed, individually or together for processing, in single or multiple instances, and that the modules themselves may include instructions for further deployment and instantiation.

Additional details regarding the EDs 110, the T-TRP 170 and the NT-TRP 172 are known to those of skill in the art. As such, these details are omitted here.

An air interface generally includes a number of components and associated parameters that collectively specify how a transmission is to be sent and/or received over a wireless communications link between two or more communicating devices. For example, an air interface may include one or more components defining the waveform(s), frame structure(s), multiple access scheme(s), protocol(s), coding scheme(s) and/or modulation scheme(s) for conveying information (e.g., data) over a wireless communications link. The wireless communications link may support a link between a radio access network and user equipment (e.g., a “Uu” link), and/or the wireless communications link may support a link between device and device, such as between two user equipments (e.g., a “sidelink”), and/or the wireless communications link may support a link between a non-terrestrial (NT)-communication network and user equipment (UE). The following are some examples for the above components.

A waveform component may specify a shape and form of a signal being transmitted. Waveform options may include orthogonal multiple access waveforms and non-orthogonal multiple access waveforms. Non-limiting examples of such waveform options include Orthogonal Frequency Division Multiplexing (OFDM), Filtered OFDM (f-OFDM), Time windowing OFDM, Filter Bank Multicarrier (FBMC), Universal Filtered Multicarrier (UFMC), Generalized Frequency Division Multiplexing (GFDM), Wavelet Packet Modulation (WPM), Faster Than Nyquist (FTN) Waveform and low Peak to Average Power Ratio Waveform (low PAPR WF).

A frame structure component may specify a configuration of a frame or group of frames. The frame structure component may indicate one or more of a time, frequency, pilot signature, code or other parameter of the frame or group of frames. More details of frame structure will be discussed hereinafter.

A multiple access scheme component may specify multiple access technique options, including technologies defining how communicating devices share a common physical channel, such as: TDMA; FDMA; CDMA; SDMA; SC-FDMA; Low Density Signature Multicarrier CDMA (LDS-MC-CDMA); Non-Orthogonal Multiple Access (NOMA); Pattern Division Multiple Access (PDMA); Lattice Partition Multiple Access (LPMA); Resource Spread Multiple Access (RSMA); and Sparse Code Multiple Access (SCMA). Furthermore, multiple access technique options may include: scheduled access vs. non-scheduled access, also known as grant-free access; non-orthogonal multiple access vs. orthogonal multiple access, e.g., via a dedicated channel resource (e.g., no sharing between multiple communicating devices); contention-based shared channel resources vs. non-contention-based shared channel resources; and cognitive radio-based access.

A hybrid automatic repeat request (HARQ) protocol component may specify how a transmission and/or a re-transmission is to be made. Non-limiting examples of transmission and/or re-transmission mechanism options include those that specify a scheduled data pipe size, a signaling mechanism for transmission and/or re-transmission and a re-transmission mechanism.

A coding and modulation component may specify how information being transmitted may be encoded/decoded and modulated/demodulated for transmission/reception purposes. Coding may refer to methods of error detection and forward error correction. Non-limiting examples of coding options include turbo trellis codes, turbo product codes, fountain codes, low-density parity check codes and polar codes. Modulation may refer, simply, to the constellation (including, for example, the modulation technique and order), or more specifically to various types of advanced modulation methods such as hierarchical modulation and low PAPR modulation.

In some embodiments, the air interface may be a “one-size-fits-all” concept. For example, it may be that the components within the air interface cannot be changed or adapted once the air interface is defined. In some implementations, only limited parameters or modes of an air interface, such as a cyclic prefix (CP) length or a MIMO mode, can be configured. In some embodiments, an air interface design may provide a unified or flexible framework to support frequencies below known 6 GHz bands and frequencies beyond the 6 GHz bands (e.g., mmWave bands) for both licensed and unlicensed access. As an example, flexibility of a configurable air interface provided by a scalable numerology and symbol duration may allow for transmission parameter optimization for different spectrum bands and for different services/devices. As another example, a unified air interface may be self-contained in a frequency domain and a frequency domain self-contained design may support more flexible RAN slicing through channel resource sharing between different services in both frequency and time.

A frame structure is a feature of the wireless communication physical layer that defines a time domain signal transmission structure to, e.g., allow for timing reference and timing alignment of basic time domain transmission units. Wireless communication between communicating devices may occur on time-frequency resources governed by a frame structure. The frame structure may, sometimes, instead be called a radio frame structure.

Depending upon the frame structure and/or configuration of frames in the frame structure, frequency division duplex (FDD) and/or time-division duplex (TDD) and/or full duplex (FD) communication may be possible. FDD communication is when transmissions in different directions (e.g., uplink vs. downlink) occur in different frequency bands. TDD communication is when transmissions in different directions (e.g., uplink vs. downlink) occur over different time durations. FD communication is when transmission and reception occurs on the same time-frequency resource, i.e., a device can both transmit and receive on the same frequency resource contemporaneously.

One example of a frame structure is a frame structure, specified for use in the known long-term evolution (LTE) cellular systems, having the following specifications: each frame is 10 ms in duration; each frame has 10 subframes, which subframes are each 1 ms in duration; each subframe includes two slots, each of which slots is 0.5 ms in duration; each slot is for the transmission of seven OFDM symbols (assuming normal CP); each OFDM symbol has a symbol duration and a particular bandwidth (or partial bandwidth or bandwidth partition) related to the number of subcarriers and subcarrier spacing; the frame structure is based on OFDM waveform parameters such as subcarrier spacing and CP length (where the CP has a fixed length or limited length options); and the switching gap between uplink and downlink in TDD is specified as the integer time of OFDM symbol duration.

Another example of a frame structure is a frame structure, specified for use in the known new radio (NR) cellular systems, having the following specifications: multiple subcarrier spacings are supported, each subcarrier spacing corresponding to a respective numerology; the frame structure depends on the numerology but, in any case, the frame length is set at 10 ms and each frame consists of ten subframes, each subframe of 1 ms duration; a slot is defined as 14 OFDM symbols; and slot length depends upon the numerology. For example, the NR frame structure for normal CP 15 kHz subcarrier spacing (“numerology 1”) and the NR frame structure for normal CP 30 kHz subcarrier spacing (“numerology 2”) are different. For 15 kHz subcarrier spacing, the slot length is 1 ms and, for 30 kHz subcarrier spacing, the slot length is 0.5 ms. The NR frame structure may have more flexibility than the LTE frame structure.

Another example of a frame structure is, e.g., for use in a 6G network or a later network. In a flexible frame structure, a symbol block may be defined to have a duration that is the minimum duration of time that may be scheduled in the flexible frame structure. A symbol block may be a unit of transmission having an optional redundancy portion (e.g., CP portion) and an information (e.g., data) portion. An OFDM symbol is an example of a symbol block. A symbol block may alternatively be called a symbol. Embodiments of flexible frame structures include different parameters that may be configurable, e.g., frame length, subframe length, symbol block length, etc. A non-exhaustive list of possible configurable parameters, in some embodiments of a flexible frame structure, includes: frame length; subframe duration; slot configuration; subcarrier spacing (SCS); flexible transmission duration of basic transmission unit; and flexible switch gap.

The frame length need not be limited to 10 ms and the frame length may be configurable and change over time. In some embodiments, each frame includes one or multiple downlink synchronization channels and/or one or multiple downlink broadcast channels and each synchronization channel and/or broadcast channel may be transmitted in a different direction by different beamforming. The frame length may be more than one possible value and configured based on the application scenario. For example, autonomous vehicles may require relatively fast initial access, in which case the frame length may be set to 5 ms for autonomous vehicle applications. As another example, smart meters on houses may not require fast initial access, in which case the frame length may be set as 20 ms for smart meter applications.

A subframe might or might not be defined in the flexible frame structure, depending upon the implementation. For example, a frame may be defined to include slots, but no subframes. In frames in which a subframe is defined, e.g., for time domain alignment, the duration of the subframe may be configurable. For example, a subframe may be configured to have a length of 0.1 ms or 0.2 ms or 0.5 ms or 1 ms or 2 ms or 5 ms, etc. In some embodiments, if a subframe is not needed in a particular scenario, then the subframe length may be defined to be the same as the frame length or not defined.

A slot might or might not be defined in the flexible frame structure, depending upon the implementation. In frames in which a slot is defined, then the definition of a slot (e.g., in time duration and/or in number of symbol blocks) may be configurable. In one embodiment, the slot configuration is common to all UEs 110 or a group of UEs 110. For this case, the slot configuration information may be transmitted to the UEs 110 in a broadcast channel or common control channel(s). In other embodiments, the slot configuration may be UE specific, in which case the slot configuration information may be transmitted in a UE-specific control channel. In some embodiments, the slot configuration signaling can be transmitted together with frame configuration signaling and/or subframe configuration signaling. In other embodiments, the slot configuration may be transmitted independently from the frame configuration signaling and/or subframe configuration signaling. In general, the slot configuration may be system common, base station common, UE group common or UE specific.

The SCS may range from 15 KHz to 480 KHz. The SCS may vary with the frequency of the spectrum and/or maximum UE speed to minimize the impact of Doppler shift and phase noise. In some examples, there may be separate transmission and reception frames and the SCS of symbols in the reception frame structure may be configured independently from the SCS of symbols in the transmission frame structure. The SCS in a reception frame may be different from the SCS in a transmission frame. In some examples, the SCS of each transmission frame may be half the SCS of each reception frame. If the SCS between a reception frame and a transmission frame is different, the difference does not necessarily have to scale by a factor of two, e.g., if more flexible symbol durations are implemented using inverse discrete Fourier transform (IDFT) instead of fast Fourier transform (FFT). Additional examples of frame structures can be used with different SCSs.

The basic transmission unit may be a symbol block (alternatively called a symbol), which, in general, includes a redundancy portion (referred to as the CP) and an information (e.g., data) portion. In some embodiments, the CP may be omitted from the symbol block. The CP length may be flexible and configurable. The CP length may be fixed within a frame or flexible within a frame and the CP length may possibly change from one frame to another, or from one group of frames to another group of frames, or from one subframe to another subframe, or from one slot to another slot, or dynamically from one scheduling to another scheduling. The information (e.g., data) portion may be flexible and configurable. Another possible parameter relating to a symbol block that may be defined is ratio of CP duration to information (e.g., data) duration. In some embodiments, the symbol block length may be adjusted according to: a channel condition (e.g., multi-path delay, Doppler shift); and/or a latency requirement; and/or an available time duration. As another example, a symbol block length may be adjusted to fit an available time duration in the frame.

A frame may include both a downlink portion, for downlink transmissions from a base station 170, and an uplink portion, for uplink transmissions from the UEs 110. A gap may be present between each uplink and downlink portion, which gap is referred to as a switching gap. The switching gap length (duration) may be configurable. A switching gap duration may be fixed within a frame or flexible within a frame and a switching gap duration may possibly change from one frame to another, or from one group of frames to another group of frames, or from one subframe to another subframe, or from one slot to another slot, or dynamically from one scheduling to another scheduling.

A device, such as a base station 170, may provide coverage over a cell. Wireless communication with the device may occur over one or more carrier frequencies. A carrier frequency will be referred to as a carrier. A carrier may alternatively be called a component carrier (CC). A carrier may be characterized by its bandwidth and a reference frequency, e.g., the center frequency, the lowest frequency or the highest frequency of the carrier. A carrier may be on a licensed spectrum or an unlicensed spectrum. Wireless communication with the device may also, or instead, occur over one or more bandwidth parts (BWPs). For example, a carrier may have one or more BWPs. More generally, wireless communication with the device may occur over spectrum. The spectrum may comprise one or more carriers and/or one or more BWPs.

A cell may include one or multiple downlink resources and, optionally, one or multiple uplink resources. A cell may include one or multiple uplink resources and, optionally, one or multiple downlink resources. A cell may include both one or multiple downlink resources and one or multiple uplink resources. As an example, a cell might only include one downlink carrier/BWP, or only include one uplink carrier/BWP, or include multiple downlink carriers/BWPs, or include multiple uplink carriers/BWPs, or include one downlink carrier/BWP and one uplink carrier/BWP, or include one downlink carrier/BWP and multiple uplink carriers/BWPs, or include multiple downlink carriers/BWPs and one uplink carrier/BWP, or include multiple downlink carriers/BWPs and multiple uplink carriers/BWPs. In some embodiments, a cell may, instead or additionally, include one or multiple sidelink resources, including sidelink transmitting and receiving resources.

A BWP is a set of contiguous or non-contiguous frequency subcarriers on a carrier, or a set of contiguous or non-contiguous frequency subcarriers on multiple carriers, or a set of non-contiguous or contiguous frequency subcarriers, which may have one or more carriers.

In some embodiments, a carrier may have one or more BWPs, e.g., a carrier may have a bandwidth of 20 MHz and consist of one BWP or a carrier may have a bandwidth of 80 MHz and consist of two adjacent contiguous BWPs, etc. In other embodiments, a BWP may have one or more carriers, e.g., a BWP may have a bandwidth of 40 MHz and consist of two adjacent contiguous carriers, where each carrier has a bandwidth of 20 MHz. In some embodiments, a BWP may comprise non-contiguous spectrum resources, which consists of multiple non-contiguous multiple carriers, where the first carrier of the non-contiguous multiple carriers may be in the mmW band, the second carrier may be in a low band (such as the 2 GHz band), the third carrier (if it exists) may be in THz band and the fourth carrier (if it exists) may be in visible light band. Resources in one carrier which belong to the BWP may be contiguous or non-contiguous. In some embodiments, a BWP has non-contiguous spectrum resources on one carrier.

Wireless communication may occur over an occupied bandwidth. The occupied bandwidth may be defined as the width of a frequency band such that, below the lower and above the upper frequency limits, the mean powers emitted are each equal to a specified percentage, β/2, of the total mean transmitted power, for example, the value of β/2 is taken as 0.5%.

The carrier, the BWP or the occupied bandwidth may be signaled by a network device (e.g., by a base station 170) dynamically, e.g., in physical layer control signaling such as the known downlink control channel (DCI), or semi-statically, e.g., in radio resource control (RRC) signaling or in signaling in the medium access control (MAC) layer, or be predefined based on the application scenario; or be determined by the UE 110 as a function of other parameters that are known by the UE 110, or may be fixed, e.g., by a standard.

User Equipment (UE) position information is often used in cellular communication networks to improve various performance metrics for the network. Such performance metrics may, for example, include capacity, agility and efficiency. The improvement may be achieved when elements of the network exploit the position, the behavior, the mobility pattern, etc., of the UE in the context of a priori information describing a wireless environment in which the UE is operating.

A sensing system may be used to help gather UE pose information, including UE location in a global coordinate system, UE velocity and direction of movement in the global coordinate system, orientation information and the information about the wireless environment. “Location” is also known as “position” and these two terms may be used interchangeably herein. Examples of well-known sensing systems include RADAR (Radio Detection and Ranging) and LIDAR (Light Detection and Ranging). While the sensing system can be separate from the communication system, it could be advantageous to gather the information using an integrated system, which reduces the hardware (and cost) in the system as well as the time, frequency or spatial resources needed to perform both functionalities. However, using the communication system hardware to perform sensing of UE pose and environment information is a highly challenging and open problem. The difficulty of the problem relates to factors such as the limited resolution of the communication system, the dynamicity of the environment, and the huge number of objects whose electromagnetic properties and position are to be estimated.

Accordingly, integrated sensing and communication (also known as integrated communication and sensing) is a desirable feature in existing and future communication systems.

Any or all of the EDs 110 and BSs 170 may be sensing nodes in the system 100. Sensing nodes are network entities that perform sensing by transmitting and receiving sensing signals. Some sensing nodes are communication equipment that perform both communications and sensing. However, it is possible that some sensing nodes do not perform communications and are, instead, dedicated to sensing. The sensing agent 174 is an example of a node that is dedicated to sensing information. Unlike the EDs 110 and BSs 170, the sensing agent 174 does not transmit or receive communication signals. However, the sensing agent 174 may communicate configuration information, sensing information, signaling information, or other information within the communication system 100. The sensing agent 174 may be in communication with the core network 130 to communicate information with the rest of the communication system 100. By way of example, the sensing agent 174 may determine the location of the ED 110a and transmit this information to the base station 170a via the core network 130. Although only one sensing agent 174 is shown in FIG. 2, any number of sensing agents may be implemented in the communication system 100. In some embodiments, one or more sensing agents may be implemented at one or more of the RANS 120.

A sensing configuration node may manage sensing-based techniques with reference signal-based techniques to enhance UE pose determination. This type of sensing configuration node may also be known as a sensing management function (SMF). In some networks, the SMF may also be known as a location management function (LMF). The SMF may be implemented as a physically independent entity located at the core network 130 with connection to the multiple BSs 170. In other aspects of the present application, the SMF may be implemented as a logical entity co-located inside a BS 170 through logic carried out by the processor 260.

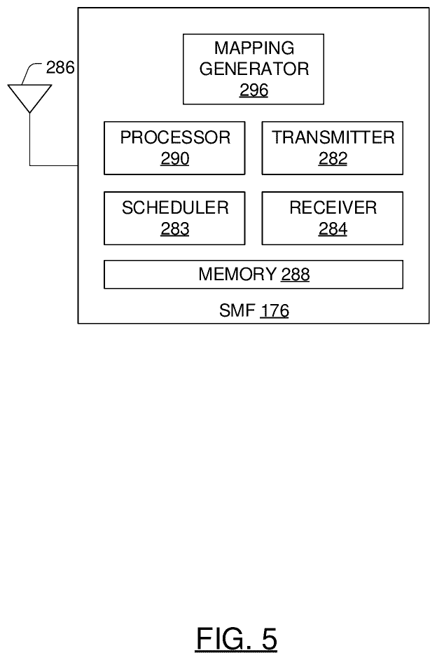

As shown in FIG. 5, an SMF 176, when implemented as a physically independent entity, includes at least one processor 290, at least one transmitter 282, at least one receiver 284, one or more antennas 286, a mapping generator 296 and at least one memory 288. A transceiver, not shown, may be used instead of the transmitter 282 and the receiver 284. A scheduler 283 may be coupled to the processor 290. The scheduler 283 may be included within or operated separately from the SMF 176. The processor 290 implements various processing operations of the SMF 176, such as signal coding, data processing, power control, input/output processing or any other functionality. The processor 290 can also be configured to implement some or all of the functionality and/or embodiments described in more detail above. Each processor 290 includes any suitable processing or computing device configured to perform one or more operations. Each processor 290 could, for example, include a microprocessor, microcontroller, digital signal processor, field programmable gate array or application specific integrated circuit.

A reference signal-based pose determination technique belongs to an “active” pose estimation paradigm. In an active pose estimation paradigm, the enquirer of pose information (e.g., the UE 110) takes part in process of determining the pose of the enquirer. The enquirer may transmit or receive (or both) a signal specific to pose determination process. Positioning techniques based on a global navigation satellite system (GNSS) such as the known Global Positioning System (GPS) are other examples of the active pose estimation paradigm.

In contrast, a sensing technique, based on radar for example, may be considered as belonging to a “passive” pose determination paradigm. In a passive pose determination paradigm, the target is oblivious to the pose determination process.

By integrating sensing and communications in one system, the system need not operate according to only a single paradigm. Thus, the combination of sensing-based techniques and reference signal-based techniques can yield enhanced pose determination.

The enhanced pose determination may, for example, include obtaining UE channel sub-space information, which is particularly useful for UE channel reconstruction at the sensing configuration node, especially for a beam-based operation and communication. The UE channel sub-space is a subset of the entire algebraic space, defined over the spatial domain, in which the entire channel from the TP to the UE lies. Accordingly, the UE channel sub-space defines the TP-to-UE channel with very high accuracy. The signals transmitted over other sub-spaces result in a negligible contribution to the UE channel. Knowledge of the UE channel sub-space helps to reduce the effort needed for channel measurement at the UE and channel reconstruction at the network-side. Therefore, the combination of sensing-based techniques and reference signal-based techniques may enable the UE channel reconstruction with much less overhead as compared to traditional methods. Sub-space information can also facilitate sub-space-based sensing to reduce sensing complexity and improve sensing accuracy.

In some embodiments of integrated sensing and communication, a same radio access technology (RAT) is used for sensing and communication. This avoids the need to multiplex two different RATs under one carrier spectrum, or necessitating two different carrier spectrums for the two different RATs.

In embodiments that integrate sensing and communication under one RAT, a first set of channels may be used to transmit a sensing signal and a second set of channels may be used to transmit a communications signal. In some embodiments, each channel in the first set of channels and each channel in the second set of channels is a logical channel, a transport channel or a physical channel.

At the physical layer, communication and sensing may be performed via separate physical channels. For example, a first physical downlink shared channel PDSCH-C is defined for data communication, while a second physical downlink shared channel PDSCH-S is defined for sensing. Similarly, separate physical uplink shared channels (PUSCH), PUSCH-C and PUSCH-S, could be defined for uplink communication and sensing.

In another example, the same PDSCH and PUSCH could be also used for both communication and sensing, with separate logical layer channels and/or transport layer channels defined for communication and sensing. Note also that control channel(s) and data channel(s) for sensing can have the same or different channel structure (format), occupy same or different frequency bands or bandwidth parts.

In a further example, a common physical downlink control channel (PDCCH) and a common physical uplink control channel (PUCCH) may be used to carry control information for both sensing and communication. Alternatively, separate physical layer control channels may be used to carry separate control information for communication and sensing. For example, PUCCH-S and PUCCH-C could be used for uplink control for sensing and communication respectively and PDCCH-S and PDCCH-C for downlink control for sensing and communication respectively.

Different combinations of shared and dedicated channels for sensing and communication, at each of the physical, transport, and logical layers, are possible.

The term RADAR originates from the phrase Radio Detection and Ranging; however, expressions with different forms of capitalization (e.g., Radar and radar) are equally valid and now more common. Radar is typically used for detecting a presence and a location of an object. A radar system radiates radio frequency energy and receives echoes of the energy reflected from one or more targets. The system determines the pose of a given target based on the echoes returned from the given target. The radiated energy can be in the form of an energy pulse or a continuous wave, which can be expressed or defined by a particular waveform. Examples of waveforms used in radar include a frequency modulated continuous wave (FMCW) waveform and an ultra-wideband (UWB) waveform.

Radar systems can be monostatic, bi-static or multi-static. In a monostatic radar system, the radar signal transmitter and receiver are co-located, such as being integrated in a transceiver. In a bi-static radar system, the transmitter and receiver are spatially separated, and the distance of separation is comparable to, or larger than, the expected target distance (often referred to as the range). In a multi-static radar system, two or more radar components are spatially diverse but with a shared area of coverage. A multi-static radar is also referred to as a multisite or netted radar.

Terrestrial radar applications encounter challenges such as multipath propagation and shadowing impairments. Another challenge is the problem of identifiability because terrestrial targets have similar physical attributes. Integrating sensing into a communication system is likely to suffer from these same challenges, and more.

Communication nodes can be either half-duplex or full-duplex. A half-duplex node cannot both transmit and receive using the same physical resources (time, frequency, etc.); conversely, a full-duplex node can transmit and receive using the same physical resources. Existing commercial wireless communications networks are all half-duplex. Even if full-duplex communications networks become practical in the future, it is expected that at least some of the nodes in the network will still be half-duplex nodes because half-duplex devices are less complex, and have lower cost and lower power consumption. In particular, full-duplex implementation is more challenging at higher frequencies (e.g., in millimeter wave bands) and very challenging for small and low-cost devices, such as femtocell base stations and UEs.

The limitation of half-duplex nodes in the communications network presents further challenges toward integrating sensing and communications into the devices and systems of the communications network. For example, both half-duplex and full-duplex nodes can perform bi-static or multi-static sensing, but monostatic sensing typically requires a sensing node have full-duplex capability. A half-duplex sensing node may perform monostatic sensing with certain limitations, such as in a pulsed radar with a specific duty cycle and ranging capability.

Enabling integrated communication and sensing may be seen as one of the main objectives for future wireless systems. Previous generations of wireless systems have typically been optimized for data communication. In principle, communication and sensing have different objectives and, as a result, previous generations of wireless systems may be considered to not have been optimized for sensing applications. In particular, it may be considered that previous generations of wireless systems have a waveform design problem. Notably, solving the waveform design problem for integrated communication and sensing systems may involve optimizing the waveform by taking into consideration both communication and sensing while avoiding major compromises in the performance of either communication or sensing.

Properties of a sensing signal, or a signal used for both sensing and communication, include the waveform of the signal and the frame structure of the signal. The frame structure defines the time-domain boundaries of the signal. The waveform describes the shape of the signal as a function of time and frequency. Examples of waveforms that can be used for a sensing signal include ultra-wide band (UWB) pulse, Frequency-Modulated Continuous Wave (FMCW) or “chirp”, orthogonal frequency-division multiplexing (OFDM), cyclic prefix (CP)-OFDM, and Discrete Fourier Transform spread (DFT-s)-OFDM.

In an embodiment, the sensing signal is a linear chirp signal with bandwidth B and time duration T. Such a linear chirp signal is generally known from its use in FMCW radar systems. A linear chirp signal is defined by an increase in frequency from an initial frequency, f_{chirp0}, at an initial time, t_{chirp0}, to a final frequency, f_{chirp1}, at a final time, t_{chirp1} where the relation between the frequency (f) and time (t) can be expressed as a linear relation of f−f_{chirp0}=α(t−t_{chirp0}), where

$$α = \frac{{f}_{chirp 1} - {f}_{chirp 0}}{{t}_{chirp 1} - {t}_{chirp 0}}$$

is defined as the chirp rate. The bandwidth of the linear chirp signal may be defined as B=f_{chirp1}−f_{chirp0} and the time duration of the linear chirp signal may be defined as T=t_{chirp1}−t_{chirp0}. Such linear chirp signal can be presented as e^{jπαt}^{²} in the baseband representation.

In other embodiments, the sensing signal is comprised of a plurality of linear chirp signals covering bandwidth B and time duration T. In case the chirp signals are separated in the time domain, i.e., M chirp signals each sweeping the bandwidth of B and non-overlapping time duration of T/M. This case may be referred to as the FMCW waveform, introduced hereinbefore. In some other embodiments, the chirp signals are separated in frequency domain, i.e., M chirp signals each sweeping a non-overlapping bandwidth of B/M and time duration of T. This embodiment may be referred to as Fractional Fourier Transform (FrFT) waveform. In some other example, a combination of FMCW and FrFT can be used as the sensing signal with or without overlapping in time/frequency domain. Although the present application provides examples and embodiments based on a single chirp signal, the subject matter of the present application may be generalized to include sensing signals using waveforms based on FMCW, FrFT or a combination of FMCW and FrFT.

Precoding, as used herein, may refer to any coding operation(s) or modulation(s) that transform an input signal into an output signal. Precoding may be performed in different domains and typically transforms the input signal in a first domain to an output signal in a second domain. Precoding may include linear operations.

A terrestrial communication system may also be referred to as a land-based or ground-based communication system, although a terrestrial communication system can also, or instead, be implemented on or in water. The non-terrestrial communication system may bridge coverage gaps in underserved areas by extending the coverage of cellular networks through the use of non-terrestrial nodes, which will be key to establishing global, seamless coverage and providing mobile broadband services to unserved/underserved regions. In the current case, it is hardly possible to implement terrestrial access-points/base-stations infrastructure in areas like oceans, mountains, forests, or other remote areas.

The terrestrial communication system may be a wireless communications system using 5G technology and/or later generation wireless technology (e.g., 6G or later). In some examples, the terrestrial communication system may also accommodate some legacy wireless technologies (e.g., 3G or 4G wireless technology). The non-terrestrial communication system may be a communications system using satellite constellations, like conventional Geo-Stationary Orbit (GEO) satellites, which utilize broadcast public/popular contents to a local server. The non-terrestrial communication system may be a communications system using low earth orbit (LEO) satellites, which are known to establish a better balance between large coverage area and propagation path-loss/delay. The non-terrestrial communication system may be a communications system using stabilized satellites in very low earth orbits (VLEO) technologies, thereby substantially reducing the costs for launching satellites to lower orbits. The non-terrestrial communication system may be a communications system using high altitude platforms (HAPs), which are known to provide a low path-loss air interface for the users with limited power budget. The non-terrestrial communication system may be a communications system using Unmanned Aerial Vehicles (UAVs) (or unmanned aerial system, “UAS”) achieving a dense deployment, since their coverage can be limited to a local area, such as airborne, balloon, quadcopter, drones, etc. In some examples, GEO satellites, LEO satellites, UAVs, HAPs and VLEOs may be horizontal and two-dimensional. In some examples, UAVs, HAPs and VLEOs may be coupled to integrate satellite communications to cellular networks. Emerging 3D vertical networks consist of many moving (other than geostationary satellites) and high altitude access points such as UAVs, HAPs and VLEOs.

MIMO technology allows an antenna array of multiple antennas to perform signal transmissions and receptions to meet high transmission rate requirements. The ED 110 and the T-TRP 170 and/or the NT-TRP may use MIMO to communicate using wireless resource blocks. MIMO utilizes multiple antennas at the transmitter to transmit wireless resource blocks over parallel wireless signals. It follows that multiple antennas may be utilized at the receiver. MIMO may beamform parallel wireless signals for reliable multipath transmission of a wireless resource block. MIMO may bond parallel wireless signals that transport different data to increase the data rate of the wireless resource block.

In recent years, a MIMO (large-scale MIMO) wireless communication system with the T-TRP 170 and/or the NT-TRP 172 configured with a large number of antennas has gained wide attention from academia and industry. In the large-scale MIMO system, the T-TRP 170, and/or the NT-TRP 172, is generally configured with more than ten antenna units (see antennas 256 and antennas 280 in FIG. 3). The T-TRP 170, and/or the NT-TRP 172, is generally operable to serve dozens (such as 40) of EDs 110. A large number of antenna units of the T-TRP 170 and the NT-TRP 172 can greatly increase the degree of spatial freedom of wireless communication, greatly improve the transmission rate, spectrum efficiency and power efficiency, and, to a large extent, reduce interference between cells. The increase of the number of antennas allows for each antenna unit to be made in a smaller size with a lower cost. Using the degree of spatial freedom provided by the large-scale antenna units, the T-TRP 170 and the NT-TRP 172 of each cell can communicate with many EDs 110 in the cell on the same time-frequency resource at the same time, thus greatly increasing the spectrum efficiency. A large number of antenna units of the T-TRP 170 and/or the NT-TRP 172 also enable each user to have better spatial directivity for uplink and downlink transmission, so that the transmitting power of the T-TRP 170 and/or the NT-TRP 172 and an ED 110 is reduced and the power efficiency is correspondingly increased. When the antenna number of the T-TRP 170 and/or the NT-TRP 172 is sufficiently large, random channels between each ED 110 and the T-TRP 170 and/or the NT-TRP 172 can approach orthogonality such that interference between cells and users and the effect of noise can be reduced. The plurality of advantages described hereinbefore enable large-scale MIMO to have a magnificent application prospect.

A MIMO system may include a receiver connected to a receive (Rx) antenna, a transmitter connected to transmit (Tx) antenna and a signal processor connected to the transmitter and the receiver. Each of the Rx antenna and the Tx antenna may include a plurality of antennas. For instance, the Rx antenna may have a uniform linear array (ULA) antenna, in which the plurality of antennas are arranged in line at even intervals. When a radio frequency (RF) signal is transmitted through the Tx antenna, the Rx antenna may receive a signal reflected and returned from a forward target.

A non-exhaustive list of possible unit or possible configurable parameters or in some embodiments of a MIMO system include: a panel; and a beam.

A panel is a unit of an antenna group, or antenna array, or antenna sub-array, which unit can control a Tx beam or an Rx beam independently.

A beam may be formed by performing amplitude and/or phase weighting on data transmitted or received by at least one antenna port. A beam may be formed by using another method, for example, adjusting a related parameter of an antenna unit. The beam may include a Tx beam and/or a Rx beam. The transmit beam indicates distribution of signal strength formed in different directions in space after a signal is transmitted through an antenna. The receive beam indicates distribution of signal strength that is of a wireless signal received from an antenna and that is in different directions in space. Beam information may include a beam identifier, or an antenna port(s) identifier, or a channel state information reference signal (CSI-RS) resource identifier, or a SSB resource identifier, or a sounding reference signal (SRS) resource identifier, or other reference signal resource identifier.

As discussed hereinbefore, there are various categories of sensing in terms of the number and locations of the sensing transmitter and receivers. Aspects of the present application focus on multi-static sensing, where there are multiple sensing transmitters and receivers. A main objective of sensing may be considered to be the determination of an estimate of a range and a velocity associated with various objects (e.g., UEs 110). The estimate may be accomplished based on estimations of sensing measurements, such as a delay and a Doppler shift experienced by sensing pilot signals. Other sensing measurements may relate to UE power, UE position, UE velocity vector, UE orientation, UE activity detection and UE imaging results.

Multi-static sensing typically makes use of specific pilot signals, which are also called “reference signals.” Such sensing pilot signals are known at the transmitter and known at the receiver. The sensing pilot signals are transmitted by the transmitter. A given sensing pilot signal that has been received by the receiver may be understood to have been altered by the channel. It follows that the receiver can process the received sensing pilot signal and, through such processing, estimate sensing measurements, such as a delay and a Doppler shift, that characterize a difference between a known transmitted version of the given sensing pilot signal and a received version of the given sensing pilot signal.

Waveforms that have been standardized for 5G NR include OFDM and DFT-s-OFDM. These waveforms may be considered to be appropriate for high data rate communication with convenient channel equalization. There are also various sensing pilot signals specified in the 5G NR standards. The specified sensing pilot signals may be shown to be restricted to the OFDM waveform. The design and optimization of such sensing pilot signals may be shown to be mainly communication oriented. Although the specified sensing pilot signals can be shown to provide some coarse information on sensing measurements (e.g., delays) that help define a propagation channel, the specified sensing pilot signals may not be considered to be suitable for future sensing applications. This may be especially true in view of the finer sensing measurements that are expected to be available from future sensing applications.

In radar literature and hereinbefore, several waveforms have been proposed for sensing applications. Aspects of the present application relate to using sensing signals using single linear chirps or a plurality of chirps based on FMCW, FrFT or a combination of FMCW and FrFT. A linear chirp is a signal whose frequency changes linearly in time. The rate at which the frequency changes occur is called a “chirp rate.” Using a single chirp signal, received at a receiver, the receiver can estimate a combined term f_{d}−ατ, where f_{d} is representative of a Doppler shift as a result of a radial velocity of the transmitter of the chirp, a is representative of a chirp rate and τ is representative of a delay corresponding to the range that the signal traverses from the transmitter to the receiver. In practice, it is preferable to have separate estimations for f_{d} and τ. Such a separation may be shown to allow for separate estimation of radial velocity and range. One way to allow for separate estimations for f_{d} and τ involves at least two chirp signals with different chirp rates. The multiple chirp signal approach allows the receiver to create, and solve, a system of equations. While chirp signals are known to provide good sensing performance, chirp signals may be considered to be inappropriate for high data rate applications.

In overview, aspects of the present application relate to multiplexing sensing pilot signals and data content signals in a manner that provides for efficient sensing and communication performance. Aspects of the present application relate to use of an OFDM waveform for data communication and use of a chirp signal for multi-static sensing. That is, a communication signal and a sensing signal are allowed to coexist. Conveniently, a time-frequency pattern of the sensing signal and other parameters for the sensing signal (e.g., a chirp rate for those cases wherein the sensing signal is a chirp signal and/or a sub-carrier spacing) may be configured on a per sensing signal transmitting node basis.

More particular aspects of the present application relate to use of a three-dimensional hopping scheme. In the scheme, sensing signal hopping occurs in time, in frequency, and in a domain of the sensing signal parameters. An example sensing signal parameter is a chirp rate. Chirp rate may be used as a parameter when a chirp signal is used for sensing. Chirp rate may be used as a generalized parameter for a family of sensing waveforms, including FMCW, FrFT and combinations of FMCW and FrFT. A sensing signal transmitting node may be defined as the entity acting as a sensing transmitter. The sensing signal transmitting node may be a TRP 170, a UE 110 or any other node in the network 100. Additionally, a set of available chirp rates, Ω={α₁, α₂, . . . , α_{N}}, may be defined, where N is representative of a quantity of available chirp rates. A base unit of the sensing time-frequency resources may be referred to as a basic resource (BR), or sensing BR, and this unit may correspond to various granularities of physical resources. A sensing BR may be a resource block or a resource block group or a bandwidth part (BWP) or a plurality of BWPs. A set of indices of sensing BRs available for sensing at a time, t, may be defined as Γₜ={i_{t,1}, i_{t,2}, . . . , i_{t,M}_{ₜ}}, where Mₜ is a quantity of sensing BRs available at time t. Note that the set of indices of available sensing BRs, It, and the indices of the sensing BRs are time variant. This time variant nature of sensing BRs may be shown to assist in hopping in the time domain and hopping in the frequency domain.

A mapping for chirp rate allocation to sensing BRs at time t for a particular sensing signal transmitting node, j, may be defined as f_{j,t}, which is a mapping from the set of available chirp rates, Ω, to the set of available sensing BRs, Γₜ. The chirp-rate mapping, f_{j,t}, may be understood to assign a subset of chirp rates to each sensing BR at time t for sensing signal transmitting node j.

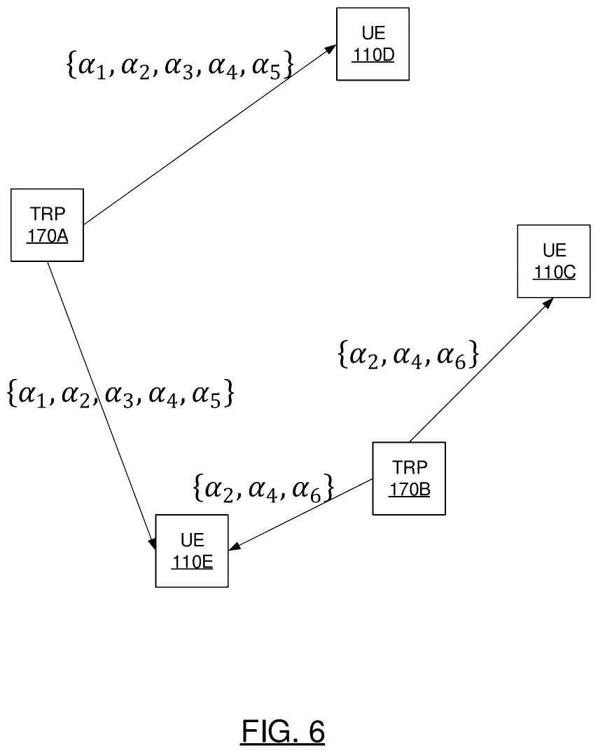

FIG. 6 illustrates an example scenario in which two TRPs, a first TRP 170A and a second TRP 170B, act as sensing signal transmitting nodes and the SMF 176 (not illustrated in FIG. 6) has assigned one chirp rate to each sensing BR per TRP 170. The example scenario of FIG. 6 also includes three UEs 110C, 110D, 110E expected to act as sensing signal receiving nodes.

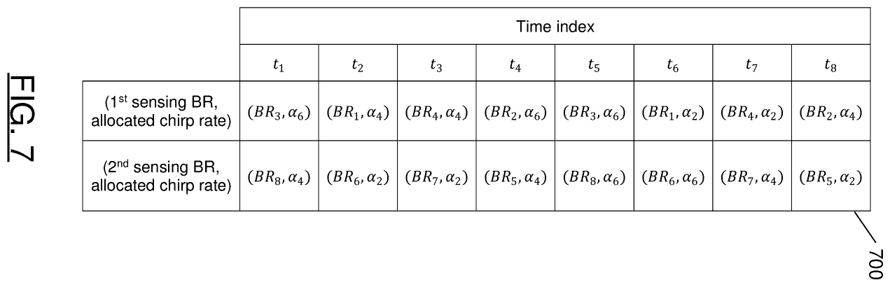

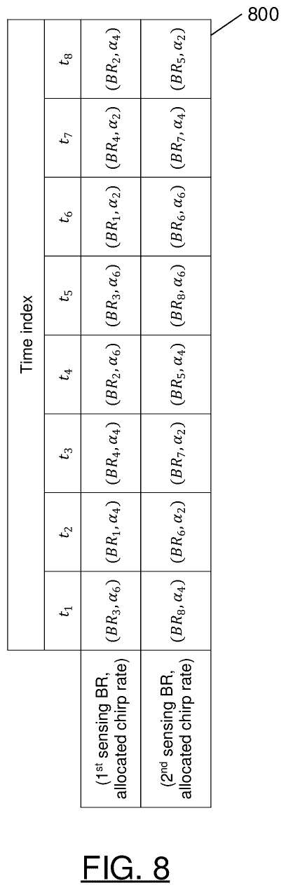

FIG. 7 illustrates a first table 700 with indications of chirp rate allocation and sensing BR allocation for the first TRP 170A of FIG. 6. FIG. 8 illustrates a second table 800 with indications of chirp rate allocation and sensing BR allocation for the second TRP 170B of FIG. 6. The set of indices of available sensing BRs at time t has been defined, hereinbefore, as Γₜ. Notably, set of indices of available sensing BRs, Γₜ, changes with time. As illustrated in FIG. 7 and FIG. 8, Γₜ_{₁}=Γₜ_{₅}={3,8}, Γₜ_{₂}=Γₜ_{₆}={1,6}, Γₜ_{₃}=Γₜ_{₇}={4,7} and Γₜ_{₄}=Γₜ_{₈}={2,5}.

Note that there are pattern changes in time, frequency, and the domain of the sensing signal parameter (i.e., chirp rate in this example). By arranging these patterns to be sensing-node-specific, it may be shown that collision in the sensing signals used by various sensing nodes (e.g., TRPs) may be minimized or avoided. One sensing signal with a specified chirp rate will be transmitted in each sensing BR by each TRP 170. In this specific example, the first TRP 170A transmits sensing signals with five distinct chirp rates and the second TRP 170B transmits sensing signals with three distinct chirp rates. The UEs 110 receive these sensing signals and use the received sensing signals to estimate delay and Doppler shift.

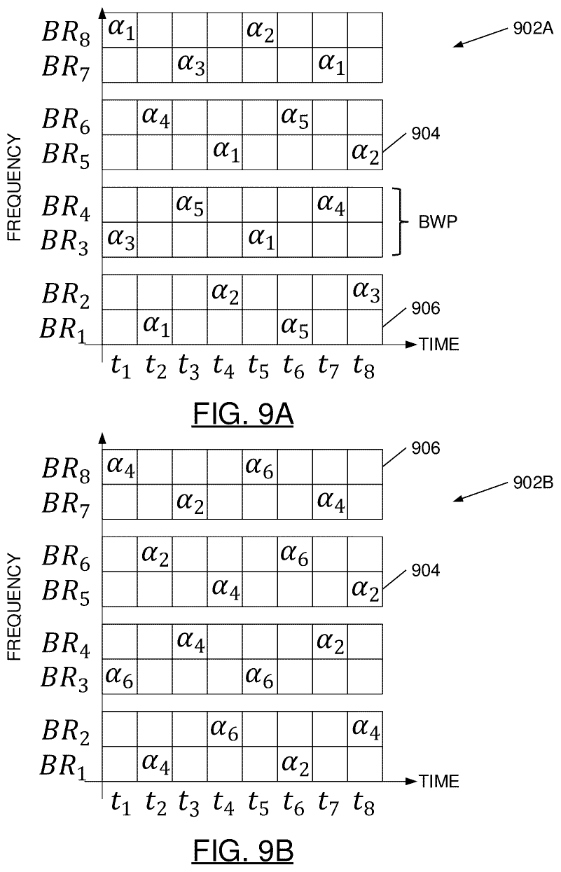

FIG. 9A illustrates a first chirp-rate mapping 902A for the first TRP 170A of FIG. 6. FIG. 9B illustrates a second chirp-rate mapping 902B for the second TRP 170B of FIG. 6. In FIG. 9A and in FIG. 9B, each table entry represents a BR, which is indicated by a frequency resource index (BR₁ . . . . BR₈) and a time resource index (t₁ . . . t₈). In FIG. 9A and in FIG. 9B, a table entry with a chirp rate (α) assigned thereto is representative of a BR allocated for sensing. Example table entries representative of BRs allocated for purposes of sensing are associated with reference numeral 904. A table entry without a chirp rate (α) assigned thereto may be considered to be representative of a BR allocated for purposes other than sensing, such as data communication, control signaling, etc. Example table entries representative of BRs allocated for purposes other than sensing are associated with reference numeral 906. Notably FIG. 7, FIG. 8, FIG. 9A and FIG. 9B, each illustrate that at each time, t, two BRs are allocated to sensing.

In the chirp-rate mappings 902A, 902B illustrated in FIG. 9A and FIG. 9B, for each TRP 170A, 170B, a chirp rate pattern defines two different the chirp rates (α) within each symbol (t). In general, for any given time duration such as a symbol, a chirp rate pattern can define no chirp, one chirp at one frequency resource, or multiple chirps at respective frequency resources. Furthermore, for the multiple chirps in the given time duration, the chirp rate pattern can define a same chirp rate for each chirp, different chirp rates for each chirp, or a combination. Thus, the set of chirp rates (α) for each symbol can change on a per-symbol basis. Notably, it is possible that some TRPs 170 share the same time-frequency and chirp rate pattern (for example, two TRPs 170 that are far from each other). Also, for a single TRP 170, different patterns can be applied alternately.

There may be shown to be several technical benefits to the use of allocations as presented in FIG. 7, FIG. 8, FIG. 9A and FIG. 9B. First, the allocation may be shown to enable concurrent communication and multi-static sensing in multi-sensing-node scenarios. This concurrent communication and multi-static sensing are facilitated by multiplexing of communication and sensing signals, and defining sensing-node-specific patterns that allow for distinguishing different sensing signal transmitting nodes. Second, using multiple chirp signals, or any other signal appropriate for sensing applications, aspects of the present application may be shown to yield accurate joint delay estimation and Doppler shift estimation. Furthermore, the proposed three-dimensional chirp hopping scheme representative of aspects of the present application may be shown to provide so-called “multiple access” that allows for avoiding or minimizing collisions while sensing.

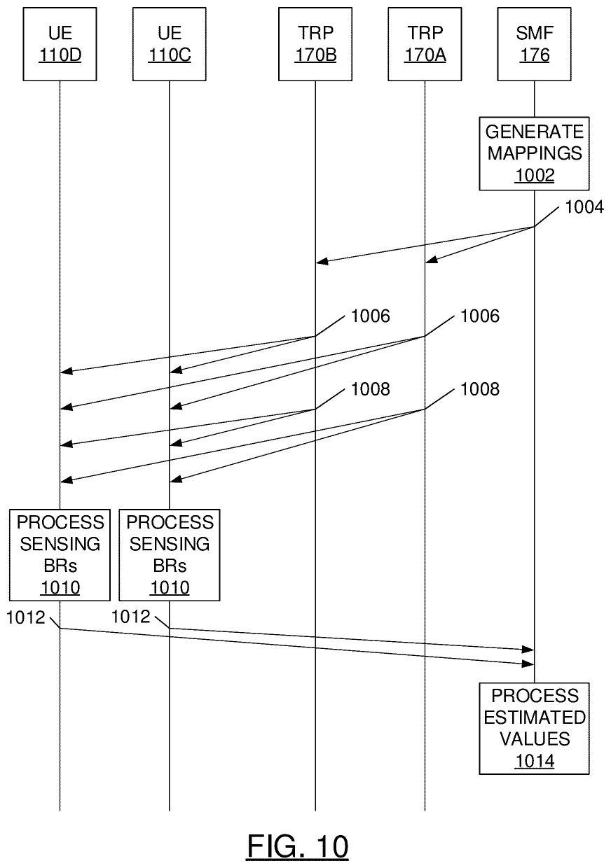

FIG. 10 illustrates, in a signal flow diagram, interaction between an SMF 176, a plurality of TRPs 170A, 170B and a plurality of UEs 110C, 110D. Initially, the SMF 176 generates (step 1002) a time-frequency pattern specific to each sensing pilot signal transmitting node. In FIG. 10, the sensing pilot signal transmitting nodes are the TRPs 170. The time-frequency pattern may, for example, include a plurality of sensing-node-specific chirp-rate-to-BR allocation mappings for a plurality of times. The TRPs 170 obtain an indication (step 1004) of the time-frequency patterns from the SMF 176. If the SMF is co-located with a given TRP, this indication may be made within an apparatus such as a base station. If the SMF is not co-located with a given TRP, this indication may be made via a backhaul connection in the core network. The TRPs 170 may transmit (step 1006) the time-frequency patterns, in full or in part, to the UEs 110. The TRPs 170 may, for example, accomplish the transmitting (step 1006) using control signaling. The TRPs 170 may, for example, accomplish the transmitting (step 1006) using dynamic signaling (e.g., L1 signaling). The TRPs 170 may indicate the time-frequency patterns explicitly, by providing the time-frequency patterns, or implicitly, by signaling indications of the transmitting node ID, the sensing node ID, or a combination thereof, and n (i.e., the number of BRs to be used for sensing), from which indications the UE 110 may determine the appropriate time-frequency pattern. The TRPs 170 generate and transmit (step 1008) sensing signals in sensing BRs based on the allocation mapping. Each UE 110 processes (step 1010) received sensing BRs from one or multiple TRPs 170. The processing (step 1010) allows the UEs 110 to obtain estimated values for sensing measurements. The sensing measurements estimated, by the UE 110, by the processing (step 1010) may include delay and Doppler shift. The sensing measurements estimated, by the UE 110, by the processing (step 1010) may optionally also include one or more of: a power, a position, a velocity vector, an orientation, a detected activity, and an imaging result. Each UE 110 may then transmit (step 1012) the estimated values for the sensing measurements to the SMF 176. The SMF 176 may, upon receipt of the estimated values, process (step 1014) the estimated values. The processing (step 1014) of the estimated values may allow the SMF 176 to determine an estimated location, in three-dimensional space, for the UE 110. Notably, the UEs 110 may not transmit (step 1012) the estimated values for the sensing measurements to the SMF 176.

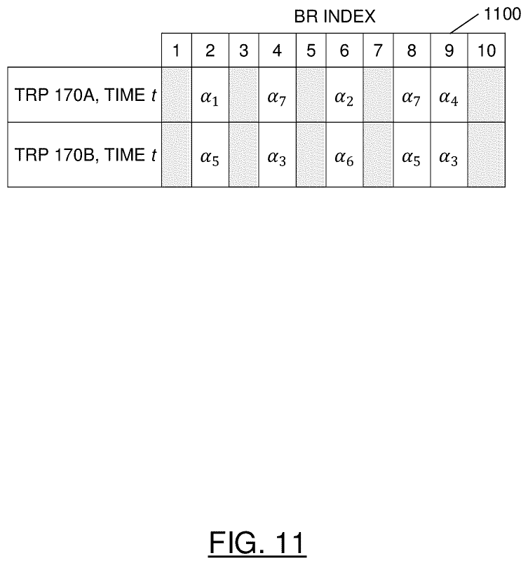

FIG. 11 illustrates an example of chirp-rate allocation mapping for the first TRP 170A and the second TRP 170B at a sample time t. The empty table entries represent BRs that are allocated to data communication and the table entries with an indicated chirp rate represent the BRs allocated to sensing. In the example of FIG. 11, the first TRP 170A is arranged to transmit four sensing signals with chirp rates α₁, α₂, α₄ and α₇. Additionally, the second TRP 170B is arranged to transmit three sensing signals with chirp rates α₃, α₅ and α₆. UEs 110 may be expected to receive the sensing signals and use the sensing signals to obtain a delay estimate and a Doppler shift estimate.

The aspects of the present application represented by FIGS. 6-11 may be shown to enable cooperative sensing in multi-TRP scenarios. Furthermore, the proposed three-dimensional chirp hopping scheme may be shown to provide multiple access for sensing while avoiding or minimizing collision. A UE 110 that receives a sensing signal from a TRP 170 may estimate a range to the TRP 170 and a radial velocity with respect to the TRP 170. Furthermore, a UE 110 may obtain a range estimate relative to each one of multiple TRPs 170 by processing sensing signals received from the multiple TRPs 170. By processing the range estimates, the UE 110 may localize itself. Note that, for such localization, it is expected that a location of each of the multiple TRPs 170 and respective chirp-rate mapping is shared with the UE 110, for example, through control channels.

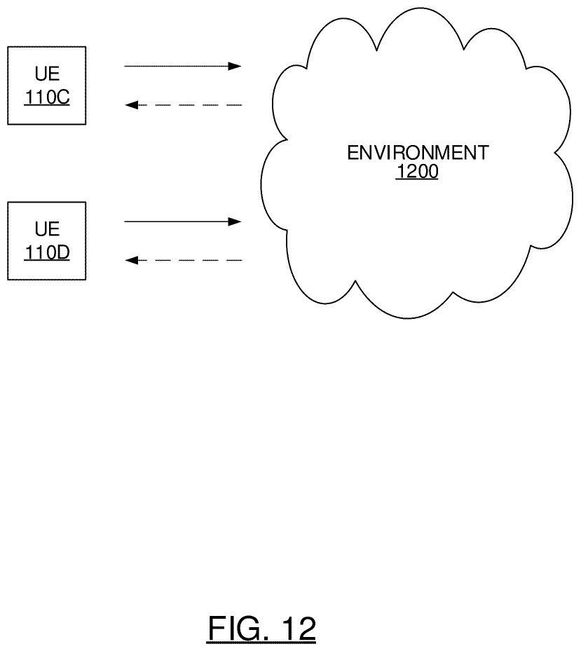

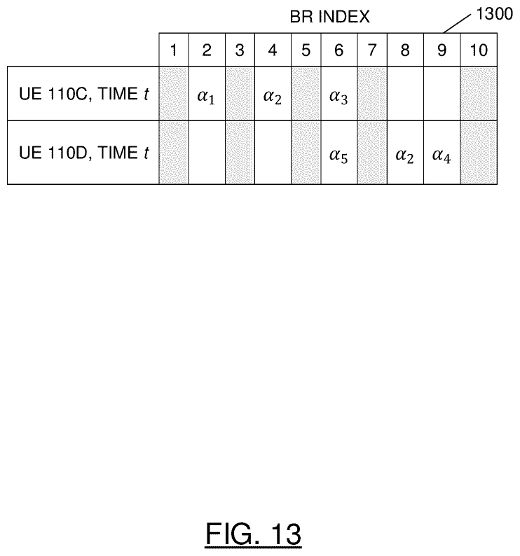

FIG. 12 illustrates a scenario in which there are two UEs, a first UE 110C and a second UE 110D, configured to act as sensing signal transmitting nodes and sensing signal receiving nodes. FIG. 13 illustrates an example table 1300 of chirp-rate allocation mapping for the first UE 110C and the second UE 110D at a sample time, t. The empty table entries show the BRs allocated to data communication and the table entries with an indicated chirp rate represent the BRs allocated to sensing. In the example of FIG. 13, the first UE 110C is configured to transmit sensing signals with chirp rates α₁, α₂ and α₃. Additionally, the second UE 110D is configured to transmit sensing signals with chirp rates α₂, α₄ and α₅. Subsequent to the transmission of the sensing signals, the UEs 110C, 110D may receive echoes of the sensing signals. The UEs 110C, 110D may then process the echoes to obtain delay estimates and Doppler shift estimates.

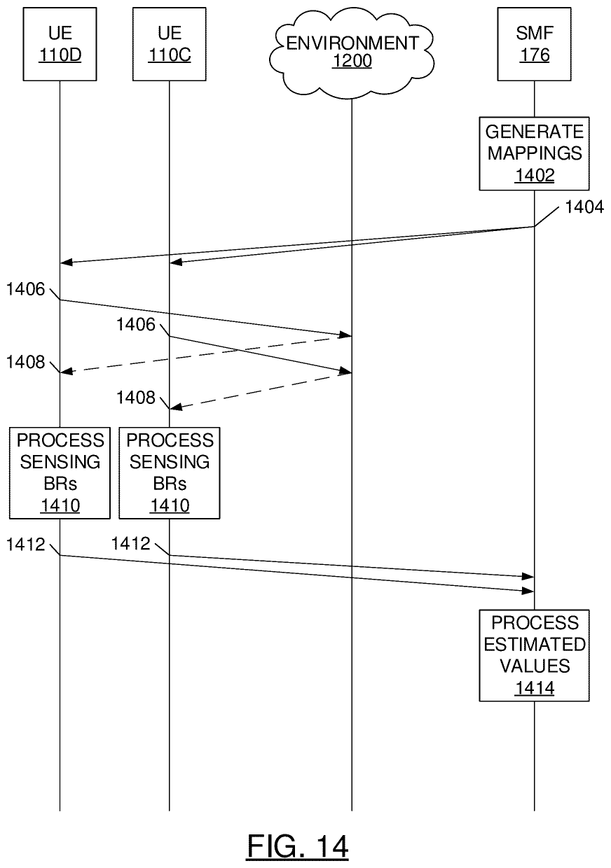

FIG. 14 illustrates, in a signal flow diagram, interaction between an SMF 176 and the elements of FIG. 12, including the environment 1200, the first UE 110C and the second UE 110D.

Initially, the SMF 176 generates (step 1402) a time-frequency pattern specific to each sensing pilot signal transmitting node. In FIG. 14, the sensing pilot signal transmitting nodes are the UEs 110. The time-frequency pattern may, for example, include a plurality of sensing-node-specific chirp-rate-to-BR allocation mappings for a plurality of times. The SMF 176 may transmit (step 1404) the time-frequency patterns to the UEs 110. The SMF 176 may, for example, accomplish the transmitting (step 1404) using control signaling. The SMF 176 may, for example, accomplish the transmitting (step 1406) using dynamic signaling (e.g., L1 signaling). The SMF 176 may indicate the time-frequency patterns explicitly, by providing the time-frequency patterns, or implicitly, by signaling indications of the transmitting node ID, the sensing node ID, or a combination thereof, and n (i.e., the number of BRs to be used for sensing), from which indications the UE 110 may determine the appropriate time-frequency pattern. The UEs 110 generate and transmit (step 1406) sensing signals in sensing BRs based on the allocation mapping. The UEs 110 receive (step 1408), from the environment 1200, reflected versions of the sensing signals. Each UE 110 processes (step 1410) the received reflected sensing signals. The processing (step 1410) allows the UEs 110 to obtain estimated values for sensing measurements. The sensing measurements estimated, by the UE 110, by the processing (step 1410) may include delay and Doppler shift. The sensing measurements estimated, by the UE 110, by the processing (step 1410) may optionally also include one or more of: a power, a position, a velocity vector, an orientation, a detected activity, and an imaging result. Each UE 110 may then transmit (step 1412) the estimated values for the sensing measurements to the SMF 176. The SMF 176 may, upon receipt of the estimated values, process (step 1414) the estimated values. The processing (step 1414) of the estimated values may allow the SMF 176 to determine an estimated location, in three-dimensional space, for the UE 110. Notably, the UEs 110 may not transmit (step 1412) the estimated values for the sensing measurements to the SMF 176.

The aspects of the present application represented by FIGS. 12, 13 and 14 may be shown to enable environment sensing for UEs 110 in multi-UE scenarios. Furthermore, the proposed three-dimensional chirp hopping scheme may be shown to provide multiple access for sensing while avoiding or minimizing collision.

In FIG. 10 and FIG. 14, the SMF 176 is illustrated as generating mappings (step 1002, step 1402). As illustrated in FIG. 5, the SMF 176 includes the mapping generator 296.

In general, the mapping generator 296 may receive as input, a number, n, of sensing BRs, a time index, t, and a sensing signal transmitting node ID, s_{ind}. The sensing signal transmitting node ID may be a node ID, a sensing ID or a combination of the node ID and the sensing ID.

The mapping generator 296 may generate (step 1002, step 1402), as output, a vector, BR_{vec}, of BRs and a corresponding vector, A_{vec}, of allocated chirp rates, for the sensing signal transmitting node (TRP 170 or UE 110) associated with the sensing signal transmitting node ID, s_{ind}, at the time index, t.

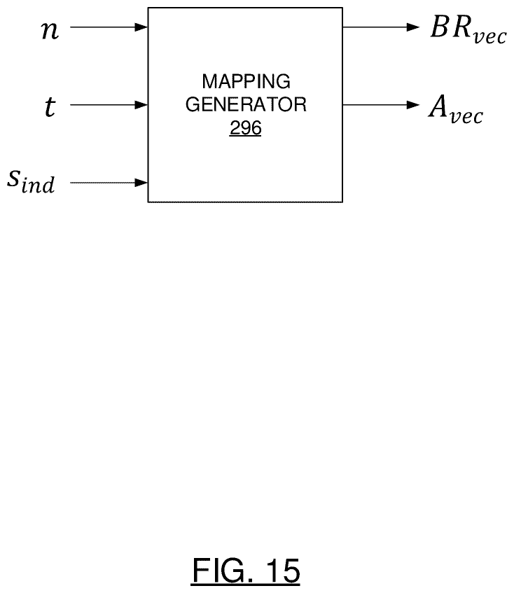

FIG. 15 illustrates the mapping generator 296 and its inputs and outputs.

The mapping generator 296 may, in one aspect of the present application, be implemented using look-up tables. The mapping generator 296 may, in other aspects of the present application, be implemented using mathematical formulas.

In the case of implementation using look-up tables, the SMF 176 may signal a table for each triple (n, t, s_{ind}) to a sensing signal transmitting node (TRP 170 or UE 110) using higher layer signaling (such as RRC or MAC Control Element—known as a “MAC-CE”). Additionally, a dynamic signaling strategy may be used. In the case of a dynamic signaling strategy, the SMF 176 may signal a plurality of tables for each triple (n, t, s_{ind}) to a sensing signal transmitting node (TRP 170 or UE 110), with each table among the plurality of tables associated with a table index. The SMF 176 may subsequently transmit a table index to allow a sensing signal transmitting node to identify which table to use. The table 700 of FIG. 7 and the table 800 of FIG. 8 are examples of implementing mappings via look-up tables.

In the case of implementation using mathematical formulas, the outputs may be established as mathematical functions of the inputs and the only parameters to be signaled dynamically are n and s_{ind} if s_{ind} is required at the receiver.

Consider the following as an example of the case where mathematical formulation is used at the mapping generator 296.

As a start, the vector of BRs, that is one of the outputs of the mapping generator 296, may be defined as BR_{vec}=[i₁, i₂, . . . , iₙ] for a time, t, where iₗ is the l^{th} BR assigned to sensing. Each element, iₗ, of the vector of BRs, BR_{vec}, may be defined using a mathematical formulation,

$${i}_{l} = ( l - 1 ) \frac{B}{n} + 1 + mod ( t , \frac{B}{n} ) ,$$

l∈{1, 2, . . . , n}, where B is the total number of BRs in the system for both communication and sensing. In this example, the mapping generator 296 assigns, to sensing, one BR out of every

$$\frac{B}{n} BRs .$$

Such an assignment may be shown to result in the vector of BRs indicating n sensing BRs, as expected. Furthermore, the inclusion of time, t, in the mathematical formulation for the index, iₗ, of sensing BRs may be shown to result in a shift in time so as to implement hopping.

Additionally, consider that A_{vec}=[α₁, . . . , αₙ] at the time t, where a is the chirp rate assigned to the BR associated with the index, it, defined hereinbefore. Recall that it is assumed that there are N chirp rates available to choose from in the set, Ω, of available chirp rates. In this example, αₗ may be selected randomly, from the set, Ω, using a deterministic seed, f_{seed}(s_{ind}, l, t). One example deterministic seed is f(s_{ind}, l, t)=2^{s}^{_{ind}}+l*t. Note that, because the seed is deterministic, the sensing signal transmitting node with ID s_{ind} can reliably determine the deterministic seed and, accordingly, the sensing signal transmitting node may determine the exact chirp rate selected, by the SMF 176, for the particular BR, at time t for the sensing signal transmitting node with ID s_{ind}.

In the case wherein there is a power boost for a sensing signal, signaling should be exchanged between the SMF 176 and the sensing signal transmitting node (TRP 170 or UE 110) to let the sensing signal transmitting node know about the power boost. Additionally, signaling is expected to be exchanged between the SMF 176 and the sensing signal receiving node (TRP 170 or UE 110) to the allow the sensing signal receiving node to record information about the power boost.

Notably, in aspects of the present application, multiple sensing signals may be assigned per sensing BR. Furthermore, in aspects of the present application, a sensing signal may carry data.

Starting from the three-dimensional chirp hopping scheme described hereinbefore, at least two additional parameter configurations may be contemplated. A first additional parameter configuration may be defined to indicate a number of sensing signals (e.g., each sensing signal associated with a distinct chirp rate) that are to be assigned per sensing BR. A second additional parameter configuration may be defined to indicate whether a given sensing signal is allowed to carry data.

Notably, in the case wherein the carrying of data by sensing signal is allowed, the data that is to be carried by the sensing signal should be selected from among data that is not delay-sensitive. A high speed backhaul may be implemented to share the data that is to be carried by the sensing signal with the sensing signal transmitting nodes and/or receiving nodes.

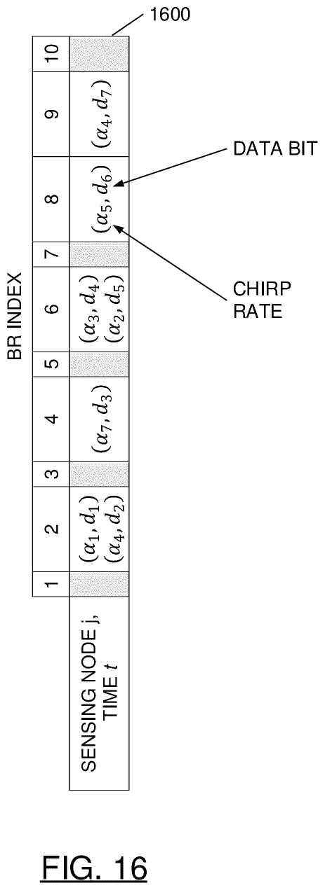

FIG. 16 illustrates an example table 1600 with indications of chirp rate allocation, data and sensing BR allocation. More particularly, the example table 1600 includes an indication of a chirp rate and data bit allocation at a time, t, for a sensing signal transmitting node, j. The empty table entries indicate the BRs that are to be used for communication. The table entries that indicate a chirp rate and data bit indicate the BRs that are to be used for sensing and the data bit that is to be carried by the sensing signal. Note that, in the example table 1600, a plurality of sensing signal-defining parameters (e.g., chirp rate) are allowed to be assigned to a single BR at a time, t.

The aspects of the present application exemplified in the table 1600 of FIG. 16 may be understood to improve the efficiency of data communication while also enabling cooperative sensing.

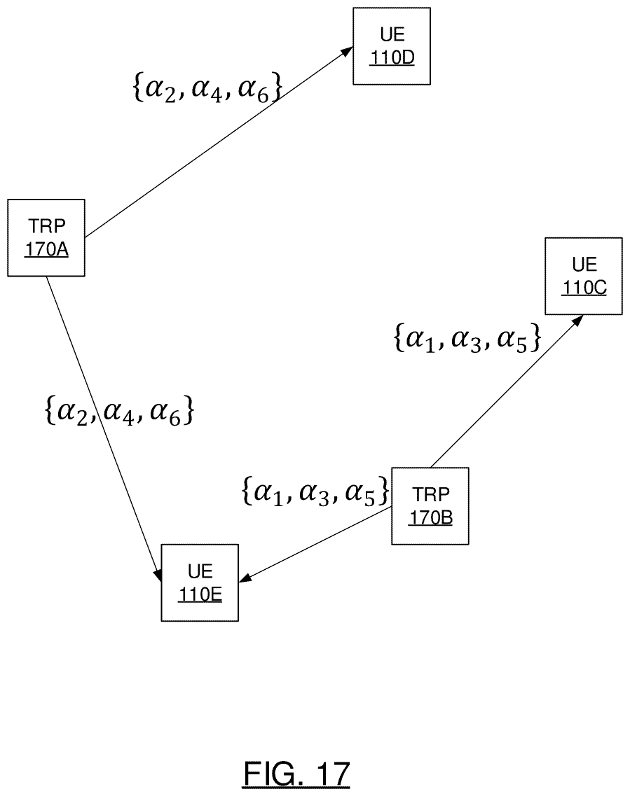

FIG. 17 illustrates a second example scenario in which two TRPs, a first TRP 170A and a second TRP 170B, act as sensing signal transmitting nodes and the SMF 176 (not illustrated in FIG. 17) has assigned chirp rates (α) to sensing BRs to be transmitted by the TRPs 170A, 170B. The second example scenario of FIG. 17 also includes three UEs 110C, 110D, 110E expected to act as sensing signal receiving nodes.

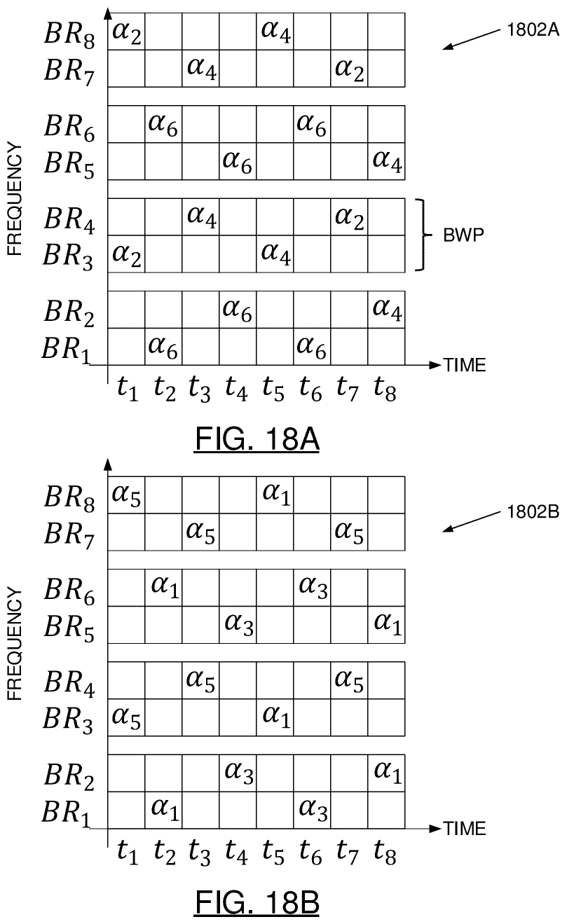

FIG. 18A illustrates a first chirp-rate mapping 1802A for the first TRP 170A of the second example scenario illustrated in FIG. 17. FIG. 18B illustrates a second chirp-rate mapping 1802B for the second TRP 170B of the second example scenario illustrated in FIG. 17. In FIG. 18A and in FIG. 18B, each table entry represents a BR. In FIG. 18A and in FIG. 18B, a table entry with a chirp rate (α) assigned thereto is representative of a BR allocated for sensing. A table entry without a chirp rate (α) assigned thereto may be considered to be representative of a BR allocated for purposes other than sensing, such as data communication, control signaling, etc.

In the mappings 1802A, 1802B illustrated in FIG. 18A and in FIG. 18B, there is one chirp rate (α) per symbol for each TRP 170. This approach may be understood to facilitate practical implementations. However, the chirp rate (α) used for each TRP 170 within a symbol may be changed on a per-symbol basis.

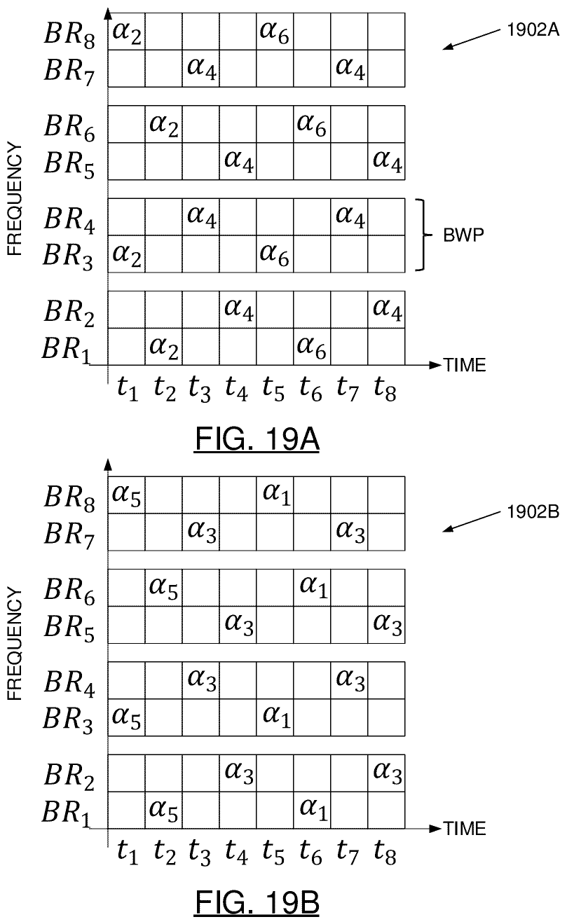

FIG. 19A illustrates a first chirp-rate mapping 1902A for the first TRP 170A of the second example scenario illustrated in FIG. 17. FIG. 19B illustrates a second chirp-rate mapping 1902B for the second TRP 170B of the second example scenario illustrated in FIG. 17.

In the first chirp-rate mapping 1902A for the first TRP 170A and the second chirp-rate mapping 1902B for the second TRP 170B, the chirp rate (α) is the same within each symbol. Additionally, the chirp rate (α) can be varied regularly every Lᵢ symbols for the i^{th} TRP. In FIG. 19A and FIG. 19B, the first chirp-rate mapping 1902A and the second chirp-rate mapping 1902B provide examples of the case wherein L₁=L₂=2.

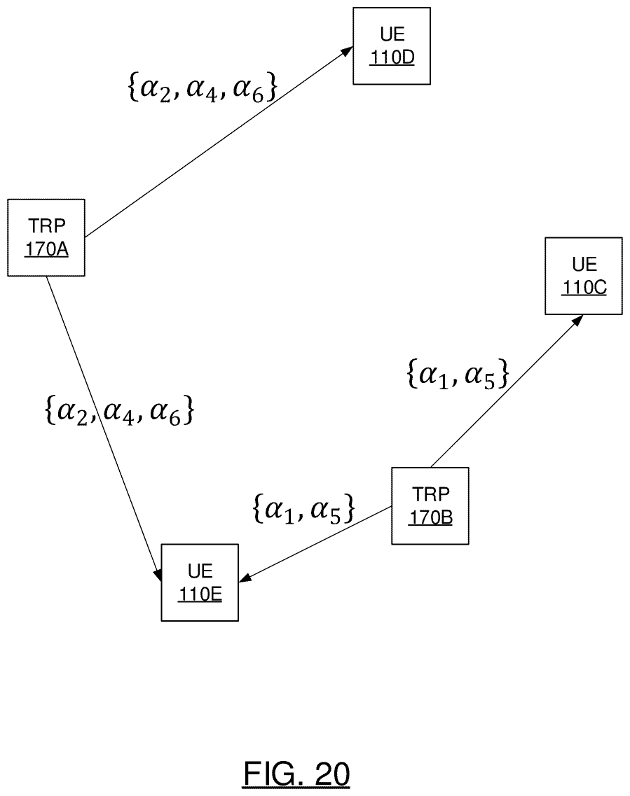

FIG. 20 illustrates a third example scenario in which two TRPs, a first TRP 170A and a second TRP 170B, act as sensing signal transmitting nodes and the SMF 176 (not illustrated in FIG. 20) has assigned chirp rates (α) to sensing BRs to be transmitted by the TRPs 170A, 170B. The third example scenario of FIG. 20 also includes three UEs 110C, 110D, 110E expected to act as sensing signal receiving nodes.

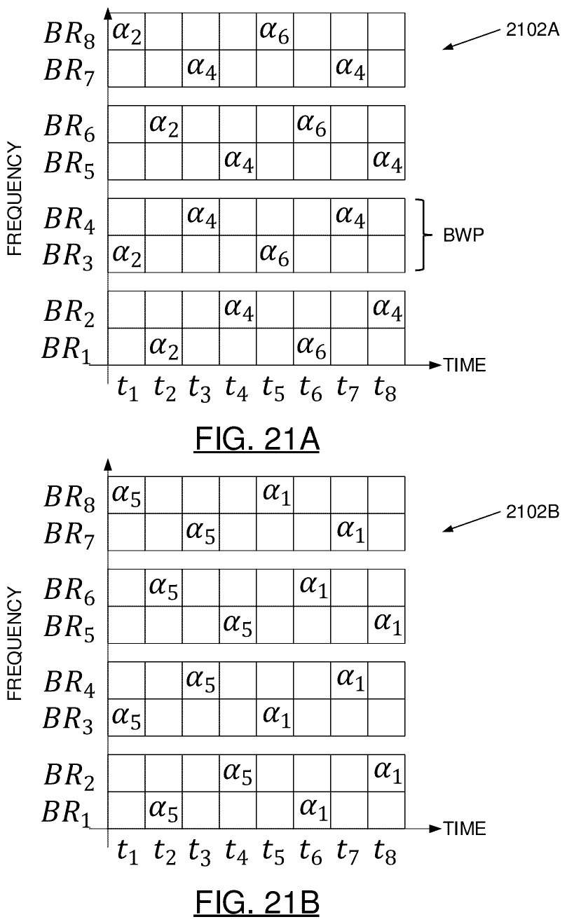

FIG. 21A illustrates a first chirp-rate mapping 2102A for the first TRP 170A of the third example scenario illustrated in FIG. 20. In FIG. 21A, the first chirp-rate mapping 2102A provides an example of the case wherein L₁=2. FIG. 21B illustrates a second chirp-rate mapping 2102B for the second TRP 170B of the third example scenario illustrated in FIG. 20. In FIG. 21B, the second chirp-rate mapping 2102B provides example of the case wherein L₂=4.

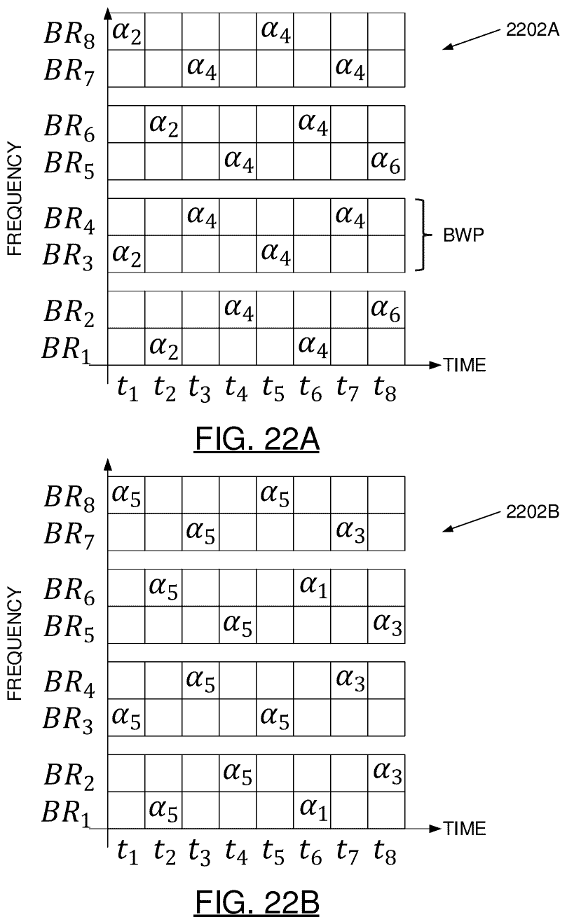

FIG. 22A illustrates a first chirp-rate mapping 2202A for the first TRP 170A of the second example scenario illustrated in FIG. 17. FIG. 22B illustrates a second chirp-rate mapping 2202B for the second TRP 170B of the second example scenario illustrated in FIG. 17.

The chirp rate (α) may be maintained the same within each symbol and the chirp rate (α) may be changed irregularly in time. For one non-limiting example, a first chirp rate may be used for four symbols, a second chirp rate may be used for the subsequent two symbols and a third chirp rate may be used for the next five symbols and so on and so forth. The first chirp-rate mapping 2202A for the first TRP 170A and the second chirp-rate mapping 2202B for the second TRP 170B each provide an example of maintaining the chirp rate within each symbol and changing the chirp rate irregularly with time.

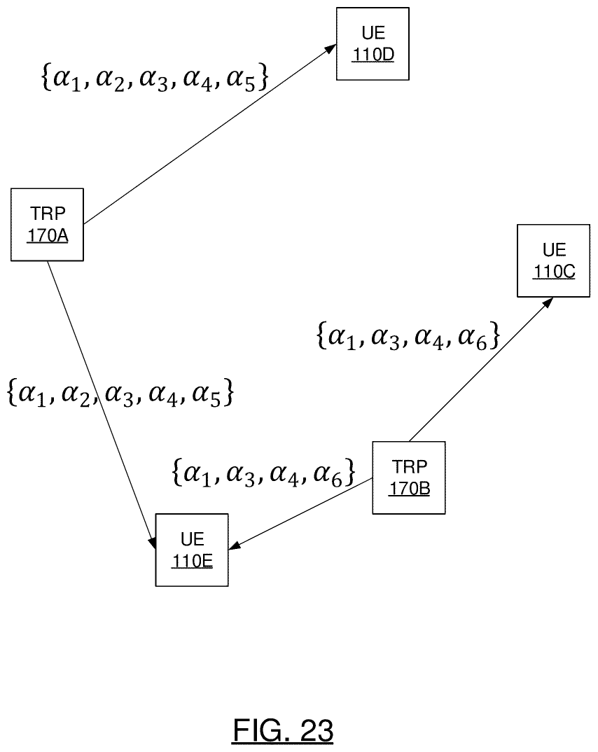

FIG. 23 illustrates a fourth example scenario in which two TRPs, a first TRP 170A and a second TRP 170B, act as sensing signal transmitting nodes and the SMF 176 (not illustrated in FIG. 23) has assigned chirp rates (α) to sensing BRs to be transmitted by the TRPs 170A, 170B. The fourth example scenario of FIG. 23 also includes three UEs 110C, 110D, 110E expected to act as sensing signal receiving nodes.

It may also be the case that multiple chirp rates may be used within each symbol. Furthermore, the set of chirp rates used per symbol may be regularly changed, say, every Lᵢ symbols for the i^{th} TRP.

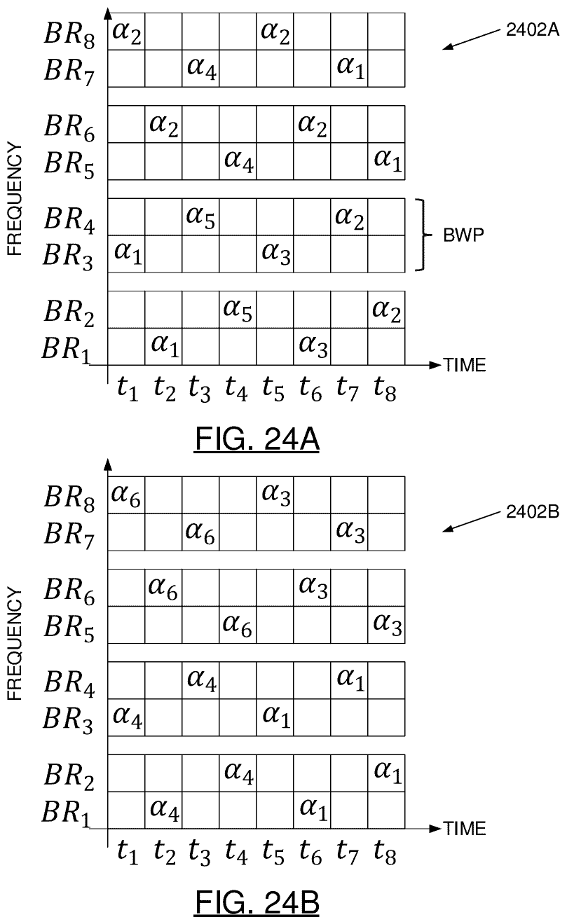

FIG. 24A illustrates a first chirp-rate mapping 2402A for the first TRP 170A of the fourth example scenario illustrated in FIG. 23. In FIG. 24A, the first chirp-rate mapping 2402A provides an example of the case wherein L₁=2. FIG. 24B illustrates a second chirp-rate mapping 2402B for the second TRP 170B of the fourth example scenario illustrated in FIG. 23. In FIG. 24B, the second chirp-rate mapping 2402B provides example of the case wherein L₂=4.

In the first chirp-rate mapping 2402A for the first TRP 170A, note that two chirp rates, {α₁, α₂}, have been assigned to the first two symbols, two chirp rates, {α₄, α₅}, have been assigned to the second two symbols, two chirp rates, {α₂, α₃}, have been assigned to the third two symbols and two chirp rates, {α₁, α₂}, have been assigned to the fourth two symbols. Additionally, in the second chirp-rate mapping 2402B for the second TRP 170B, note that two chirp rates, {α₄, α₆}, have been assigned to the first four symbols and two chirp rates {α₁, α₃} have been assigned to the second four symbols.

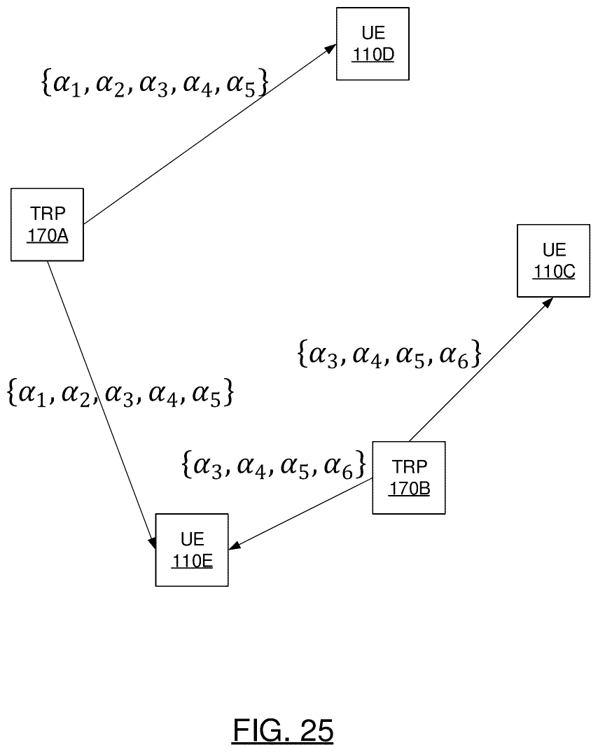

FIG. 25 illustrates a fifth example scenario in which two TRPs, a first TRP 170A and a second TRP 170B, act as sensing signal transmitting nodes and the SMF 176 (not illustrated in FIG. 25) has assigned chirp rates (α) to sensing BRs to be transmitted by the TRPs 170A, 170B. The fifth example scenario of FIG. 25 also includes three UEs 110C, 110D, 110E expected to act as sensing signal receiving nodes.

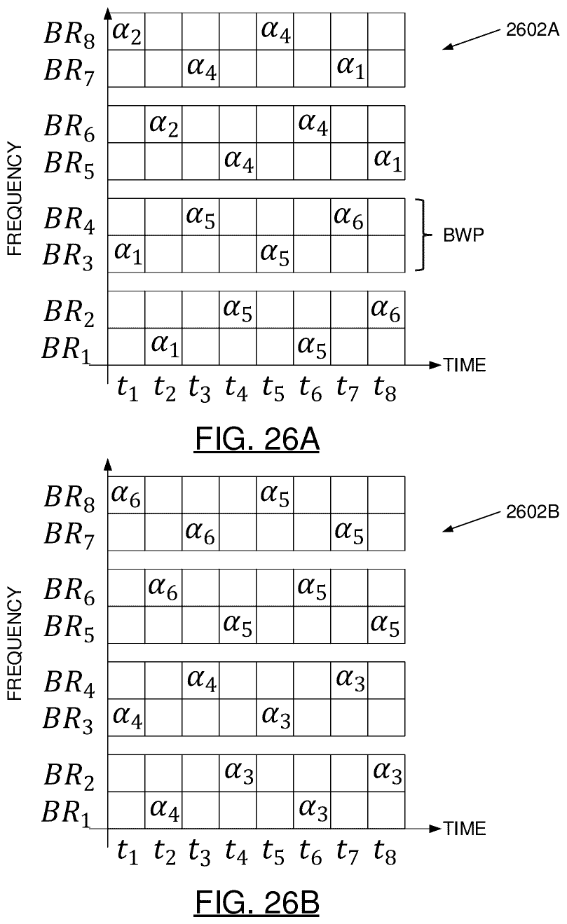

FIG. 26A illustrates a first chirp-rate mapping 2602A for the first TRP 170A of the fifth example scenario illustrated in FIG. 25. FIG. 26B illustrates a second chirp-rate mapping 2602B for the second TRP 170B of the fifth example scenario illustrated in FIG. 25.

In the first chirp-rate mapping 2602A for the first TRP 170A and the second chirp-rate mapping 2602B for the second TRP 170B, multiple chirp rates (α) are used for each symbol. Furthermore, the set of chirp rates (α) used per symbol for each TRP 170 is illustrated as being modified irregularly in time. For the first chirp-rate mapping 2602A, a first set of chirp rates, {α₂, α₁}, is illustrated as being used for the first TRP 170A for two symbols, then a second set of chirp rates, {α₄, α₅}, is illustrated as being used for the four subsequent symbols and a third set of chirp rates, {α₁, α₆}, is illustrated as being used for the two subsequent symbols. For the second chirp-rate mapping 2602B, a first set of chirp rates, {α₆, α₄}, is illustrated as being used for the second TRP 170B for three symbols and a second set of chirp rates, {α₅, α₃}, is illustrated as being used for the five subsequent symbols.

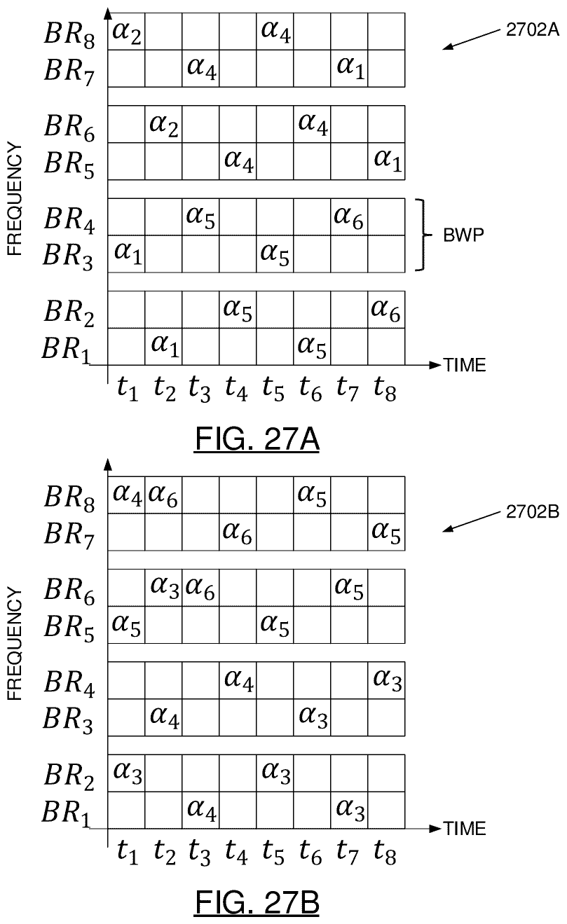

FIG. 27A illustrates a first chirp-rate mapping 2702A for the first TRP 170A of the fifth example scenario illustrated in FIG. 25. FIG. 27B illustrates a second chirp-rate mapping 2702B for the second TRP 170B of the fifth example scenario illustrated in FIG. 25.

In the first chirp-rate mapping 2702A for the first TRP 170A and the second chirp-rate mapping 2702B for the second TRP 170B, the time-frequency resources allocated to sensing are illustrated as being varied for the different TRPs 170. Furthermore, the chirp rate (α) may be changed over time and frequency resources. The combination of FIG. 27A and FIG. 27B illustrates an example wherein different time-frequency resource patterns are used for the two TRPs 170.

In the cases discussed hereinbefore, indices of time-frequency resources allocated to sensing, indices of time-frequency resources allocated to communication, as well as the chirp rates (α) assigned to each time-frequency resource unit can be shared with a given TRP 170 using control signaling, such as RRC signaling. Additionally, a part, or all, of the indices of time-frequency resources allocated to sensing for one or multiple TRPs 170, a part, or all, of the indices of time-frequency resources allocated to communication for one or multiple TRPs 170, as well as a part, or all, of the chirp rates (α) assigned to each time-frequency resource unit for one or multiple TRPs 170 may be shared with a UE 110 by control signaling.

In addition to distinct time-frequency resources for communication signals and sensing signals, overlapped time-frequency resources for communication signals and sensing signals are contemplated.

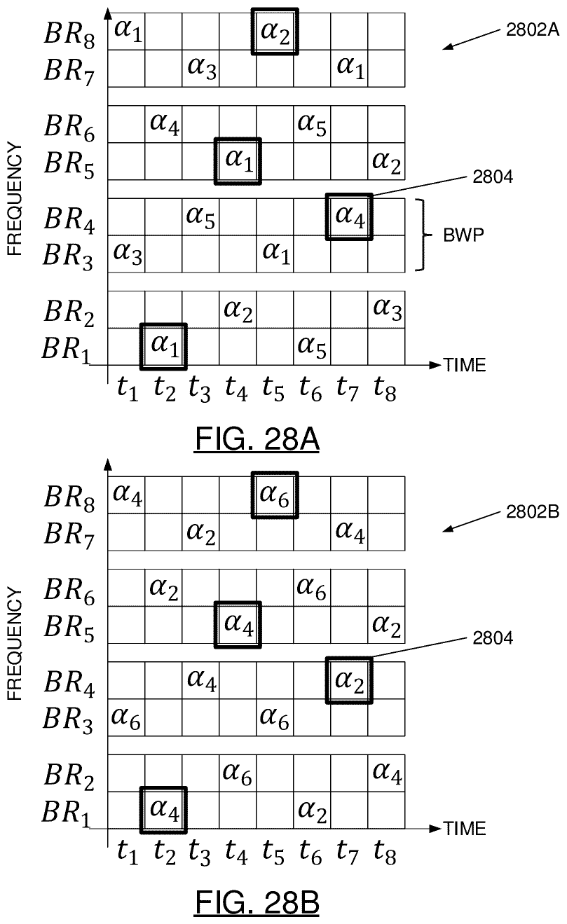

FIG. 28A illustrates a first chirp-rate mapping 2802A for the first TRP 170A of the first example scenario illustrated in FIG. 6. FIG. 28B illustrates a second chirp-rate mapping 2802B for the second TRP 170B of the first example scenario illustrated in FIG. 6.

FIG. 28A and FIG. 28B illustrate examples wherein a BR 2804 illustrated with a chirp rate (α) surrounded by a bold square may be seen as representative of a BR allocated for both communication signals and sensing signals.

Note that in the example provided in FIG. 28A and FIG. 28B, time-frequency resources used for sensing signals and communication signals are partially overlapped. It is also contemplated that time-frequency resources used for sensing signals and communication signals may fully overlap. As illustrated in examples presented hereinbefore, time-frequency resources used for sensing signals and communication signals may have no overlap.

For those cases wherein time-frequency resources used for sensing signals and communication signals at least partially overlap, the transmission (step 1004, FIG. 10), by the SMF 176, of the allocation mappings to the TRPs 170 may include: an indication of a sensing waveform; an indication of a time-frequency pattern (e.g., a pattern index) allocated to the sensing signal; an indication of a granularity for the sensing signal; and an indication of an extent (none, partial, or full) to which time-frequency resources for sensing signals are to be shared with communication signals.

Notably, granularity may be understood to be a time-frequency parameter assigned to each sensing signal unit. The parameter may be representative of a bandwidth. Bandwidth may be represented by a quantity of resource elements, by a quantity of resource blocks or by a value representative of an absolute bandwidth. The parameter may be representative of a time duration. The time duration may be represented by a quantity of OFDM symbols or an absolute time duration.

As discussed hereinbefore, the TRPs 170 may transmit (step 1006, FIG. 10) the allocation mappings, received from the SMF 176, to the UEs 110. Based on the information in the allocation mappings, a given UE 110 may opt for rate matching or interference aware detection. Furthermore, it is contemplated that each TRP 170 may determine a time-frequency pattern for sensing and communication (i.e., the allocation of time-frequency resources to sensing signals and to communication signals) and whether to have overlapping time-frequency resources for sensing signals and communication signals. Such information may be transmitted (step 1006, FIG. 10), through control channels, to the UEs 110.

As discussed in view of FIG. 10, the TRPs 170 may transmit (step 1006) time-frequency patterns, in full or in part, to the UEs 110. As discussed in view of FIG. 14, the SMF 176 may transmit (step 1404) the time-frequency patterns to the UEs 110. The time-frequency patterns need not be static. That is, the time-frequency patterns may be defined in the context of a pre-defined time duration and a pre-defined bandwidth. A given time-frequency pattern may be employed over a pre-defined time duration and, upon expiration of the pre-defined time duration, a distinct time-frequency pattern may be employed. Notably, a first time-frequency pattern may be pre-defined to be employed over a pre-defined time duration in a first bandwidth and a second time-frequency pattern may be pre-defined to be employed over the same pre-defined time duration in a second bandwidth. The starting time and the starting frequency may be signaled separately from the signaling (step 1006 of FIG. 10, step 1404 of FIG. 14) of indexes to the time-frequency patterns. It should be understood that, when pre-defined (indexed) time-frequency patterns are to be employed, there are at least three types of signaling. A first type of signaling may be related to the allocation of a time/frequency region for sensing. This first type of signaling may be accomplished using dynamic signaling like L1 or higher-layer signaling like RRC and MAC-CE. A second type of signaling may be related to the time duration and bandwidth of the basic resource for pattern definition, the time-frequency patterns and the indices of the time-frequency patterns. This second type of signaling may be accomplished using higher layer signaling like RRC and MAC-CE. A third type of signaling may be related to the configuration of pattern indices for a UE 110. This third type of signaling may be accomplished using dynamic signaling like L1 or higher-layer signaling like RRC and MAC-CE.

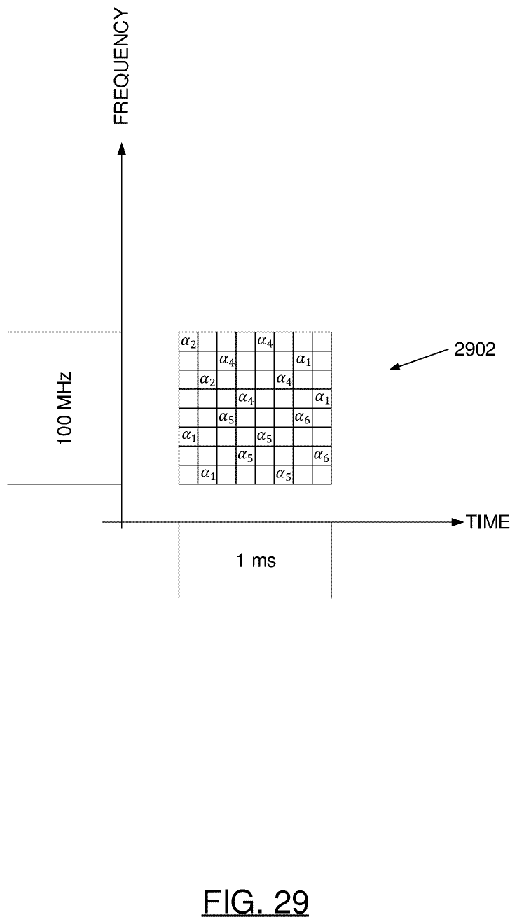

FIG. 29 illustrates a basic example, wherein a time-frequency pattern 2902 is defined over 1 ms (a pre-defined time duration) and over a particular 100 MHz in frequency (a pre-defined bandwidth). In this case, the overall time duration of the time units within the time-frequency pattern amount to 1 ms and the total bandwidth corresponding to all the BRs within the time-frequency pattern is 100 MHz. The time-frequency pattern 2902 illustrated in FIG. 29 may be associated with an index to distinguish the time-frequency pattern 2902 from a plurality of other time-frequency patterns, each associated with a corresponding index.

The indices allow the TRP 170 or the SMF 176 to pre-configure (not shown) a UE 110 with a plurality of time-frequency patterns, with each of the time-frequency patterns associated with an index. Subsequent to the pre-configuring, the TRP 170 may transmit (step 1006), to the UE 110, an index to a time-frequency pattern, rather than the full time-frequency pattern. Similarly, the SMF 176 may transmit (step 1404) an index to a time-frequency pattern. A given time-frequency pattern may be associated with a distinct index when the given time-frequency pattern is to be implemented in a distinct bandwidth. The TRP 170 or the SMF 176 may employ the indices to indicate, to the UE 110, a time-frequency pattern of time-frequency patterns.

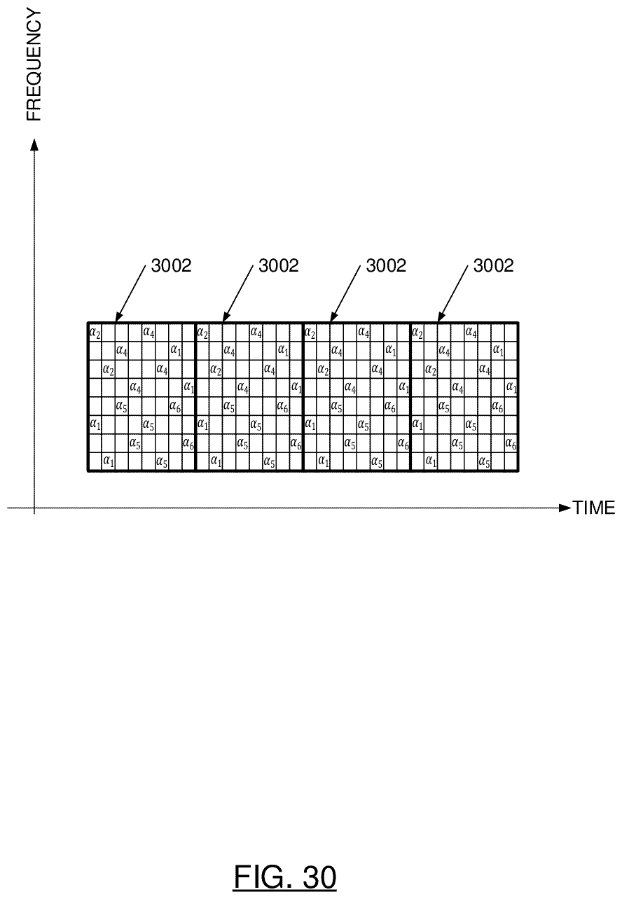

In a simple case, illustrated in FIG. 30, a time-frequency pattern of time-frequency patterns may indicate that a given time-frequency pattern 3002 is to be repeated four times.

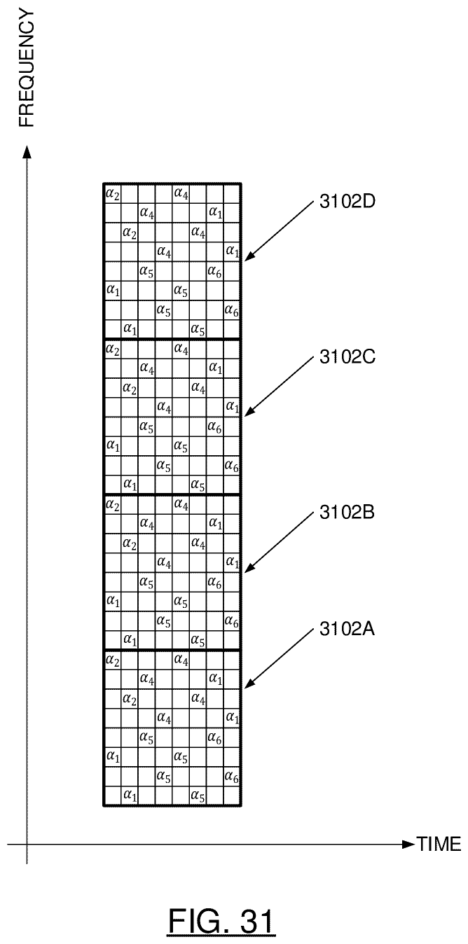

In another case, illustrated in FIG. 31, a time-frequency pattern of time-frequency patterns may indicate that a single time-frequency pattern is to be implemented in four bandwidths. Even though time-frequency patterns 3102A, 3102B, 3102C, 3102D (collectively or individually 3102) are identical, each time-frequency pattern 3102 is associated with a distinct index to convey that the time-frequency pattern 3102 is to be implemented in a particular frequency range.

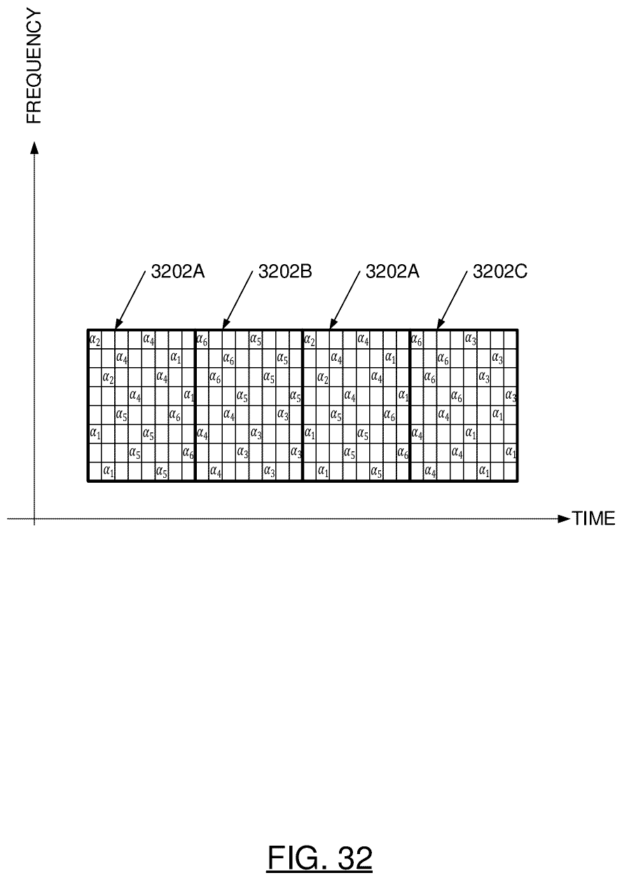

In another case, illustrated in FIG. 32, a time-frequency pattern including a plurality of time-frequency patterns may indicate that the plurality of time-frequency patterns are to be implemented according to a prescribed order. There are three time-frequency patterns 3202A, 3202B, 3202C (collectively or individually 3202) and an example prescribed order indicates that the time-frequency patterns 3202 are to be implemented in an A-B-A-C order.

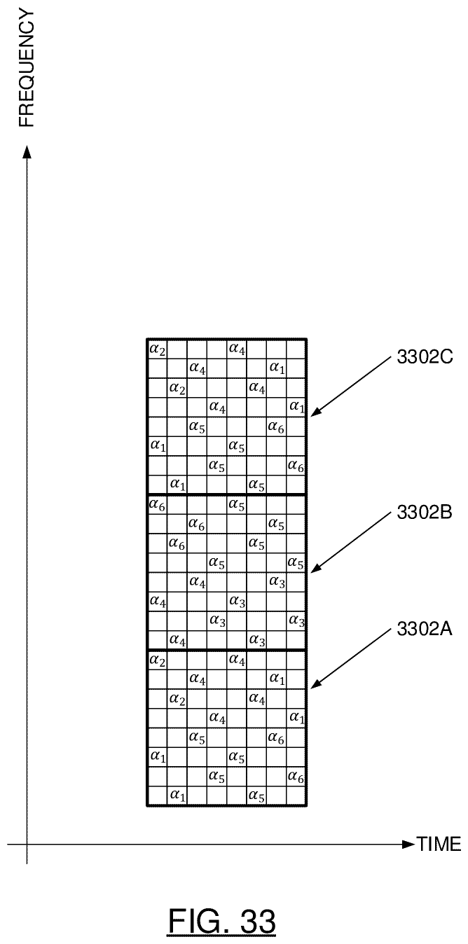

In another case, illustrated in FIG. 33, a time-frequency pattern including a plurality of time-frequency patterns may indicate that the plurality of time-frequency patterns are to be implemented in the same time slot and different frequency ranges. There are two time-frequency patterns implemented over three frequency ranges. Although a first time-frequency pattern 3302A and a third time-frequency pattern 3302C are the same pattern, the time-frequency patterns 3302A, 3302C are associated with distinct indices because the time-frequency patterns 3302A, 3302C are to be implemented in distinct frequency ranges. The frequency range for the first time-frequency pattern 3302A is centered at a lower frequency than a frequency range for a second time-frequency pattern 3302B. The frequency range for the third time-frequency pattern 3302C is centered at a higher frequency than the frequency range for the second time-frequency pattern 3302B.

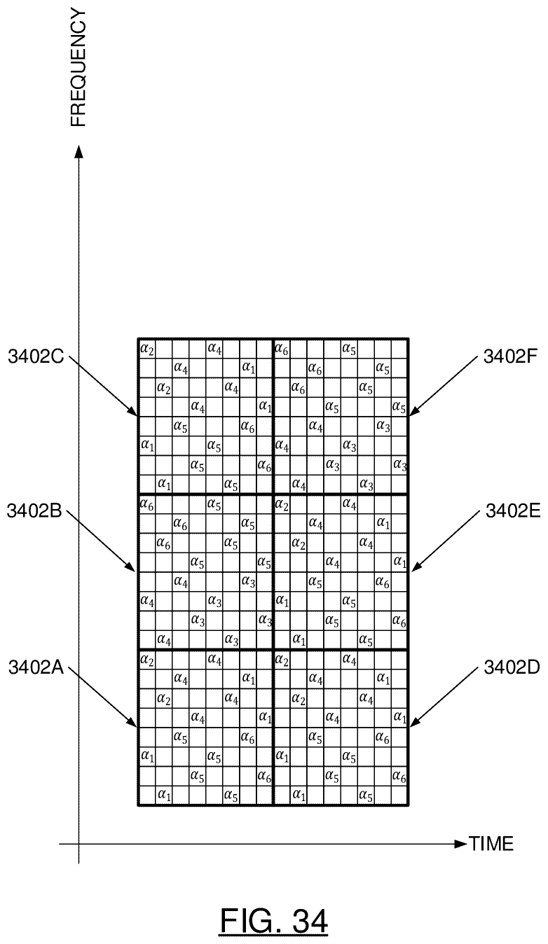

The TRP 170 or the SMF 176 may indicate, to the UE 110, a time-frequency pattern including a plurality of time-frequency patterns using a vector of indices or multiple vectors of indices. In a further case, illustrated in FIG. 34, a time-frequency pattern including a plurality of time-frequency patterns may indicate that the plurality of indexed time-frequency patterns are to be implemented in various time slots and various frequency ranges. In FIG. 34, a plurality of time-frequency patterns 3402A, 3402B, 3402C, 3402D, 3402E, 3402F are distributed over time slots and frequency ranges.

It is preferred that sensing does not significantly impact communication performance. Conveniently, then, the aspects of the present application that relate to sparse sensing patterns in the time-frequency domain may be shown to leave most of a given resource to be used for data communication purposes.

It is preferred to have multiple access for sensing to avoid collisions or, at least, minimize the chance of collision, maximize the diversity of sensing signal allocation and enable efficient cooperative sensing. It is convenient, then, that the aspects of the present application that relate to a sensing signal parameter allocation scheme are sensing-node-specific. It is noted that the sensing signal parameter disclosed herein is a chirp rate. Clearly, if a sensing signal other than a chirp is used, the sensing signal parameter that defines the sensing signal will be distinct from chirp rate.

It is preferred, for each sensing signal transmitting node, to have sparse sensing pilot signals to cover a large bandwidth over time. It is convenient, then, that the aspects of the present application that relate to a sensing pattern disclose a sensing pattern with hopping in time and in frequency. It may be shown that, a result of implementing the sensing pattern is that sensing pilot signals can effectively cover a large bandwidth.

Because the sensing pattern is sparse, the possibility of a transmit power boost for sensing pilots signals is contemplated. Such a transmit power boost is expected to obviate coverage limitations due to the power penalty associated with sparsity.

It should be appreciated that one or more steps of the embodiment methods provided herein may be performed by corresponding units or modules. For example, data may be transmitted by a transmitting unit or a transmitting module. Data may be received by a receiving unit or a receiving module. Data may be processed by a processing unit or a processing module. The respective units/modules may be hardware, software, or a combination thereof. For instance, one or more of the units/modules may be an integrated circuit, such as field programmable gate arrays (FPGAs) or application-specific integrated circuits (ASICs). It will be appreciated that where the modules are software, they may be retrieved by a processor, in whole or part as needed, individually or together for processing, in single or multiple instances as required, and that the modules themselves may include instructions for further deployment and instantiation.

Although a combination of features is shown in the illustrated embodiments, not all of them need to be combined to realize the benefits of various embodiments of this disclosure. In other words, a system or method designed according to an embodiment of this disclosure will not necessarily include all of the features shown in any one of the Figures or all of the portions schematically shown in the Figures. Moreover, selected features of one example embodiment may be combined with selected features of other example embodiments.

Although this disclosure has been described with reference to illustrative embodiments, this description is not intended to be construed in a limiting sense. Various modifications and combinations of the illustrative embodiments, as well as other embodiments of the disclosure, will be apparent to persons skilled in the art upon reference to the description. It is therefore intended that the appended claims encompass any such modifications or embodiments.

What is claimed is:

1. A method comprising:
obtaining, at a sensing pilot signal transmitting node, a time-frequency pattern specific to the sensing pilot signal transmitting node, wherein the time-frequency pattern indicates, for a first plurality of resource blocks:
a second plurality of resource blocks that are to be used for transmitting a plurality of sensing pilot signals, and
a sensing pilot signal parameter for each sensing pilot signal among the plurality of sensing pilot signals; and
transmitting, to a sensing pilot signal receiving node and in accordance with the time-frequency pattern, a particular sensing pilot signal among the plurality of sensing pilot signals.

2. The method of claim 1, further comprising:
receiving an echo of the particular sensing pilot signal; and
obtaining an estimate of a sensing measurement that characterizes a difference between the particular sensing pilot signal and the echo of the particular sensing pilot signal.

3. The method of claim 1, wherein the sensing pilot signal transmitting node comprises a transmit/receive point.

4. The method of claim 1, wherein the sensing pilot signal transmitting node comprises a user equipment.

5. The method of claim 1, wherein the particular sensing pilot signal comprises a chirp.

6. The method of claim 5, wherein the sensing pilot signal parameter comprises a chirp rate.

7. The method of claim 1, wherein the sensing pilot signal parameter comprises a sub-carrier spacing.

8. The method of claim 1, wherein the time-frequency pattern indicates that a further plurality of resource blocks are to be used for transmitting data content signals.

9. The method of claim 1, wherein the time-frequency pattern indicates a single sensing pilot signal parameter for a particular first resource block among the first plurality of resource blocks.

10. An apparatus comprising:
at least one non-transitory memory storing instructions;
at least one processor caused, by executing the instructions, to:
obtain a time-frequency pattern specific to a sensing pilot signal transmitting node, wherein the time-frequency pattern indicates, for a first plurality of resource blocks:
a second plurality of resource blocks that are to be used for transmitting a plurality of sensing pilot signals, and
a sensing pilot signal parameter for each sensing pilot signal among the plurality of sensing pilot signals; and
a transmitter adapted to transmit, to a sensing pilot signal receiving node and in accordance with the time-frequency pattern, a particular sensing pilot signal among the plurality of sensing pilot signals.

11. The apparatus of claim 10, wherein the sensing pilot signal transmitting node comprises at least one of a transmit/receive point and a user equipment.

12. A method comprising:
receiving, at a sensing pilot signal receiving node from a sensing pilot signal transmitting node, a time-frequency pattern specific to the sensing pilot signal transmitting node, wherein the time-frequency pattern indicates, for a first plurality of resource blocks:
a second plurality of resource blocks that are to be used for transmitting a plurality of sensing pilot signals, and
a sensing pilot signal parameter for each sensing pilot signal among the plurality of sensing pilot signals;
receiving, from the sensing pilot signal transmitting node, a received version of a particular sensing pilot signal among the plurality of sensing pilot signals; and
transmitting an estimate of a sensing measurement that characterizes a difference between a transmitted version of the particular sensing pilot signal and the received version of the particular sensing pilot signal.

13. The method of claim 12, wherein the sensing pilot signal transmitting node comprises a transmit/receive point.

14. The method of claim 12, wherein the sensing pilot signal transmitting node comprises a user equipment.

15. The method of claim 12, wherein the sensing pilot signal comprises a chirp.

16. The method of claim 15, wherein the sensing pilot signal parameter comprises a chirp rate.

17. The method of claim 12, wherein the sensing pilot signal parameter comprises a sub-carrier spacing.

18. The method of claim 12, wherein the time-frequency pattern indicates that a further plurality of resource blocks are to be used for transmitting data content signals.

19. The method of claim 12, wherein the time-frequency pattern indicates a single sensing pilot signal parameter for a particular first resource block among the first plurality of resource blocks.

20. An apparatus comprising:
a receiver adapted to:
receive, from a sensing pilot signal transmitting node, a time-frequency pattern specific to the sensing pilot signal transmitting node, wherein the time-frequency pattern indicating, for a first plurality of resource blocks:
a second plurality of resource blocks that are to be used for transmitting a plurality of sensing pilot signals, and
a sensing pilot signal parameter for each sensing pilot signal among the plurality of sensing pilot signals;
receive, from the sensing pilot signal transmitting node, a received version of a particular sensing pilot signal among the plurality of sensing pilot signals; and
a transmitter adapted to transmit an estimate of a sensing measurement that characterizes a difference between a transmitted version of the particular sensing pilot signal and the received version of the particular sensing pilot signal.
